(19) United States
(12) Patent Application Publication
(10) Pub. No.: US 2019/0264646 A1
(43) Pub. Date: Aug. 29, 2019

(54) ORBITAL-EPICYCLIC CRANKSHAFT WITH ECVC CYCLE AT TDC OR BDC

(71) Applicant: Boris Zivkovich, Hammond, IN (US)

(72) Inventor: Boris Zivkovich, Hammond, IN (US)

(21) Appl. No.: 16/175,443

(22) Filed: Oct. 30, 2018

Related U.S. Application Data
(63) Continuation-in-part of application No. 15/166,255, filed on May 26, 2016, now Pat. No. 10,113,623.

(51) Int. Cl. F02N 15/06; F01L 1/352; F16H 1/28

(52) U.S. Cl. CPC F02N 15/06; F16H 1/2818; F01L 1/352

(57) ABSTRACT

An improved internal combustion engine utilizes at least one orbital pin eccentrically offset from an orbital shaft, rotationally linked to the main shaft via an epicyclic gear set, such that the piston and connecting rod, influenced by the force from thermodynamic process, transfers a straight linear force to the orbital epicyclic pin further via the flying crank arm to the main shaft. This results in an extended but mechanically adjustable constant volume combustion period up to 60° with improved piston to crank relationship throughout main conversion angle. The extended dwell duration and new piston to crank relationship at TDC and BDC improve the engine operation as well as its scavenging efficiency and cleanliness.

### TECHNICAL FIELD

The present disclosure is related generally to internal combustion engines and, more particularly to a system and method for providing a substantially constant but adjustable volume period within the combustion cycle and/or adjustable/extended dwell time of a physical reciprocating motion of a mechanical element.

### BACKGROUND

Under an onslaught of regulatory and economic demands, reciprocating internal combustion engines (ICEs) have come very close to peak efficiency and NOX emission reduction. However, such engines, both spark-ignited and compression-ignited, are facing new challenges with respect to mileage and efficiency due to the price of petroleum and petroleum distillates.

Existing spark and compression-ignited ICEs utilize a crankshaft with a connecting crank pin that remains at a constant distance from the center of the main crankshaft journal. This structure, based on the wheel and eccentric pin, has been used essentially unchanged since the 14^{th} century to produce very simple reciprocating mechanical movements, i.e., to break stones, calendar cereals, and for hammering and shaping metals.

The eccentric pin with constant distance to the center of rotation was inherited and implemented in external heat Alfa Sterling steam engines, which were conceived and patented by Jean-Joseph Etienne Lenoir in 1860. A short time later in 1867 Paris, Nicholas August Otto constructed and demonstrated the first internal combustion engine. Continuing this progress, Herbert Stuart invented the first fuel pressure-injected internal combustion engine in 1891, and in 1892 Rudolf Diesel patented essentially the same structure with four cycle operation.

For turn of the century industry and society, the eccentric pin with constant distance to the center of rotation in an external engine was a useful concept due to external preparation of the pressure. For example, a steam engine does not benefit from any amount of piston dwell time at TDC (top dead center) and new piston to crankshaft relationship. Indeed, extended dwell time would cause the steam charge to lose a small amount of heat or energy, reducing efficiency.

However, for use in ICEs, the eccentric pin with constant distance to the center of rotation has numerous disadvantages, especially with respect to the piston's movement around top dead center. This mechanical arrangement sets an inadequate but mechanically permanent piston to crank relationship. In the first 90° of moving from BDC (bottom dead center) toward TDC, the piston is moving relatively slowly, meaning that the temperature of the charge is also only increasing slowly. In second 90° of crank rotation from BDC, the piston has a longer more linear response, which means it travels faster and raises the charge temperature faster. This sequence sets very strict parameters, requiring sophisticated combustion management process and techniques. Thus only very controlled octane-hexagon proportions of the fuel will sustain the changes of the values distributed exponentially to given time constant. This inadequate piston to crank relationship with piston moving too fast at the end of its physical reciprocating motion directly causes a secondary imbalance of the forces.

Moreover, the existing eccentric pin at constant distance provides only a brief moment at and around TDC with no volume changes. Indeed, without allowing for slight looseness in tolerances, there is essentially no constant volume regime anywhere along the piston's travel. Allowing for tolerances, and using a loose definition of “constant,” perhaps one could say that from −4° to +4° ( 1/45 of 360°) the piston doesn't change the volume of the combustion chamber appreciably. At 720 RPM, this period would last 0.0018 sec. Increasing RPM from idle speed to max. For instance to 7200 RPM, the pseudo-constant volume regime duration at TDC will be further cut to a tenth of that.

The lack of time at TDC and inadequate volumetric increase while performing power stroke versus crank time has been generally known, and solutions have been attempted by using a variety of the systems to compensate for these deficiencies. Various systems such as: variable ignition with common rail direct fuel injection system, variable intake runners and sophisticated combustion management systems have been used to guide and supervise the combustion process before and after TDC. In the conventional mechanical concept, using today's fuel, the combustion process must start substantially before TDC, creating a huge resistance by raising the heat chemically in parallel with physical compression. The ignition of the charge is happening while the flat plane crankshaft is in its power gap; especially with higher RPMs, the concept relies on using accumulated flywheel torque to complete the last stage of the compression stroke.

The crank pin with constant distance to the center of rotation has then partially developed thermodynamic processes and only partially converted thermal energy to useful mechanical work throughout power stroke. When spark ignited, the mechanical concept has a maximum thermal efficiency of about 30%, with the rest of the energy being lost in the form of unfinished combustion gasses which are then exposed to multiple techniques and after-treatment accessories in order to remediate the incomplete combustion process. Some of these after processes are known, e.g., recompression, where the exhaust valve still remains closed while the piston starts moving from the BDC up extending the burning process further into exhaust cycle, pipe flow of the gases is further exposed to rotate the turbocharger turbine where is constantly maintaining higher pressure and heat in order to stimulate further atomization.

At the end of this very important method by conventional concept and closer to the end piston motion the system enters EGR system returning portion of unburned gases to next intake cycle. The unburned gases past this point are further exposed to other after treatment accessories like two or three way catalytic converters. Compression ignited concepts, e.g., diesels, use an excess volume of fuel, relying on using the techniques mentioned above and additional EGR, DPF, DEF to remediate the failure of the mechanical concept. This all proves that the conventional crankshaft design limits the thermodynamic process to a certain level of efficiency.

Thanks to the development of many conventional improvements such as VVT and VVL, engine combustion management systems are able to pick and choose the profile of the combustion process, the size of the charge coordinated with your request and driving conditions, as well as direct fuel injection system, have allowed the conventional ICE concept with its own inadequate piston to crank relationship to withstand competition. Since the beginning of its development until today, many attempts have been made to change the conventional crank system, piston to crank relationship. However, all such attempts resulted in even faster volumetric increase with piston after TDC, while the conventional crank already lacks sufficient time at that stage of the stroke for a fuller atomization process.

While the present disclosure is directed to a system that can eliminate certain shortcomings noted in or apparent from this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art currently in the public domain. As such, the inventors expressly disclaim this section as admitted or assumed prior art. Moreover, the identification herein of a desirable course of action reflects the inventors' own observations and ideas, and should not be assumed to indicate an art-recognized desirability.

### SUMMARY

In keeping with an embodiment of the disclosed principles, an improved internal combustion engine utilizes at least one orbital crank journal rotationally linked to the main crank journal, diametrically offset from the center of the orbital body-axis 22a with C2 in a specific way as further described in paragraphs below. The orbital crank journal together with orbital body and planetary gear are geared to the sun gear fixed to the block via a 1:1 gearing ratio, with identical pitch circle radius. In this way, the orbiting pin is influenced by expansion of the gases inside the cylinder via connecting rod turning the orbital crank journal around its center and the orbiting center and uses the epicyclic motion of the two gears to create Variable Rod to Stroke Ratio mechanical concept. This epicyclic motion creates an irregular but vertically symmetrical circular path of the center of orbiting pin (journal), thus resulting in extended constant volume period up to 60° crank time engaging the piston with the crank in a new and advanced mechanical relationship. Simply engaging the piston with right spin at right crank angular position, improves the operation, thermal efficiency and cleanliness of the engine. Other features and aspects of embodiments of the disclosed principals will be appreciated from the detailed disclosure taken in conjunction with the included figures.

### BRIEF DESCRIPTION OF THE SEVERAL VIEWS OF THE DRAWING

While the appended claims set forth the features of the present techniques with particularity, these techniques, together with their objects and advantages, may be best understood from the following detailed description taken in conjunction with the accompanying drawings of which.

FIG. 1 is a schematic illustration showing resolution of the shortcomings of the conventional mechanical concept with revolving crank pin (journal) in a constant distance to the center of rotation. The following Variable Rod-Stroke Ratio mechanical concept is a unique mechanical concept and is presented here to: modify the conventional cycle's time duration, dwell time, piston to crank relationship and shortness of the crank lever while in the second half of cycle (power stroke). The figure illustrates the creation of an irregular circular path using mechanical elements engaged in a new fashion to achieve the modification of conventional cycles. The figure uses simplified presentation and contents as follow; orbital pin (journal) C1, orbital body axis with center labeled as C2, main journal axis rotatable affixed in the block with center C3, planetary gear helical tooth style 5 with the same center C2 as orbital body axis, stationary collar gear with helical tooth style one piece construction 6, pitch circles 5a and 5b, pitch radius of the planetary gear pr1, pitch radius of stationary gear labeled as pr2.

FIG. 2 is a detail view of FIG. 1, presenting the geometrical creation of ECVC at TDC. Further schematic illustration of a crankshaft with planetary gear 5 and a sun gear 6 fixed to the block, orbiting the orbital eccentric journal 4 with center C1 partially from 30° bTDC to 30° after TDC creating ECVC of 60°, in accordance with an embodiment of the disclosed principles.

FIG. 3 is a detail view of ½ of the system shown in FIG. 1, with the planetary shaft and center C1 engaged in an epicyclic orbit around the center of revolving and orbiting center C2 to create Extended Constant Volume Combustion Cycle (ECVC) at TDC or BDC (EDDUR).

FIG. 4 is a 3D view of one crank throw of an orbital epicyclic crankshaft embodying VR/SR mechanical principles of engine operation. Further shown are disassembled elements in accordance with an embodiment of the disclosed principles of a single orbital epicyclic crank pin which demonstrates simple ability to reconfigure engines kinematics. Turning the orbital shaft around its own center for 180° before meshing the gear with stationary to the block sun collar gear 6 will set the extended dwell duration (EDDUR) and slower piston response to crank rotation at BDC point. The specific crankshaft draft is further seen and implemented in an opposed piston-opposed cylinder concept with partial sequential animation and 2D view in the FIGS. 48 & 49.

FIG. 5 is the 3D view of an orbital epicyclic crankshaft embodying the variable rod to stroke ratio (VR/SR) mechanical principal. The figure shows one crankshaft throw assembled in accordance with an embodiment of the disclosed principles with split orbital epicyclic pins opposed for 180° around revolving and orbiting center of the shaft for a horizontal four piston engine concept. The presented crank throw has the same reconfiguring ability as described in paragraph 17.

FIG. 6 is a 3D view of a crankshaft throw with a mechanically detached orbital shaft for better understanding the simplicity of the engaged elements of the system in accordance with an embodiment of the disclosed principles.

FIG. 7 is a 2D view of a complete flat plane VR/CR crankshaft for a horizontal engine with opposed orbital journals on one orbital shaft in accordance with an embodiment of the disclosed principles. Contents of the figure are orb. journal center C1, revolving and orbital center C2, the main center of rotation C3, opposed crank journal on the same orb. shaft C4 opposed crank throw orbital journals C5, C6, with optional two piece construction of collar helical sun gear 6a and 6b, horizontally opposed crank throw 8, orbital cap 22, flywheel flange 23, and two-part thrust motion termination ring 24.

FIG. 8 is a cutaway view of one crankshaft throw with schematic illustration of helical sun gear with collar 6, orbital planetary gear 5, orbital journal 4, main shaft 7, counterweights 7a, block wall 18, oil film bearings 19, excess mass for removal 20, oil galleries 21, orbital shaft axis 22a, and main oil supply 25, in accordance with an embodiment of the disclosed principles.

FIG. 9 presents a PV diagram of compression and expansion cycles with comparable data plots showing the cylinder pressure curves for a traditional engine 110 and an engine in accordance with an embodiment of the disclosed principles 111. Projected VR/SR network is based on the new piston to crank relationship, where the reduction of the volumetric displacement has direct impact on MEP and cylinder pressure. The system provides additional dwell time after TDC allowing variable ignition to accrue from 5°-15° after the TDC point. Delaying the ignition and beginning of fuel propagation for better crank pin position reduces the lateral stress onto components and bypasses normally excessive resistance of the expansion of ignited gases before TDC. Accordingly, this reduces the dependence on flywheel torque to complete the second half of the compression cycle, where the engine with conventional flat plane crankshaft is left with power gap.

The epicyclic crankshaft together with orbital elements revolves around the center C2 to 30° after TDC and holds the charge in a volumetrically entrapped position without interrupting the angular momentum of the entire system. Throughout this crank rotation orbital center C1 maintains a lower crank arm equal to 22° of the conventional crankshaft. Slower volumetric increase from 30°-75° after TDC creates an environment for better fuel propagation and fuller atomization, resulting in improvement of the dual cycle 114.

FIG. 10 presents theoretical and practical operational cycles in the PV diagram under 111. Element 112 shows expression of the thermodynamic processes in the PV diagram. 1-2 Isentropic compression, 2-3 Constant volume heat input qin, 3-4 Constant volume and pressure input (qin), 4-5 Isentropic expansion. The improved piston to crank mechanical relationship provides an environment for substantial improvement of Limited Pressure Cycle (Dual cycle) by spark or pressure ignited cycle. The system provides a greater difference between the value at state 4 versus the value at state 3.

FIGS. 11-22 are a schematic virtual operating diagrams of the VR/SR mechanical concept compared with the conventional model, both using square bore to stroke ratio and the same Rod to Stroke Ratio of 1.75:1.

FIG. 23 is a 2D view of the horizontal engine concept using VR/SR crankshaft in accordance with an embodiment of the disclosed principals, where the ECVC is set to appear at TDC point.

FIG. 24 is a schematic illustration of the VR/SR concept in accordance with a horizontal embodiment of the disclosed principals.

FIGS. 25-31 are schematic illustrations and partial animations of the crankshaft and crank pin operation system in accordance with an embodiment of the disclosed principles with ECVC mechanically set to appear at TDC for four-cycle concepts, implemented in V6, 120°.

FIGS. 32-40 present the implementation of an epicyclic crankshaft with setting of EDDUR at BDC point for two cycle engine operation where the fresh air enters the cylinder through ports before and after BDC point where the concept utilizes a hydraulically controlled exhaust valve in the head of the engine.

FIGS. 41-49 show an ultimate VR/SR OPOC concept, where ECVC is mechanically set to appear at DBC point and its implementation in opposed piston layout two cycle with exhaust port and intake port around BDC and having fuel injectors in the middle of the cylinder.

### DETAILED DESCRIPTION

Before presenting a fuller discussion of the disclosed principals, an overview is given to aid the reader in understanding the later material. As noted above, a constant radius eccentric pin system as is used in ICE has numerous disadvantages, especially with respect to the piston's movement around TDC and the piston to crank relationship after the TDC and around the BDC point. The piston to crank relationship has a direct impact on the level of extraction and conversion of energy from the thermodynamic process.

In general, these problems include complex charging requirements, inefficient combustion, complex injection, sophisticated combustion management systems, number of after treatment accessories and techniques to support further fuel atomization of extra reach mixture intentionally created in order to slightly raise the thermal efficiency. However, the invention, in certain embodiments, allows the combustion in the chamber to be held at a constant volume at and around TDC up to 60°. This feature prolongs the period during which effective ignition and combustion after conventional TDC can take the place, leading to greater thermal efficiency, reduction of operational energy, reduction of flow by gasses during increase of the load and reduction of lateral stress to mechanical joints.

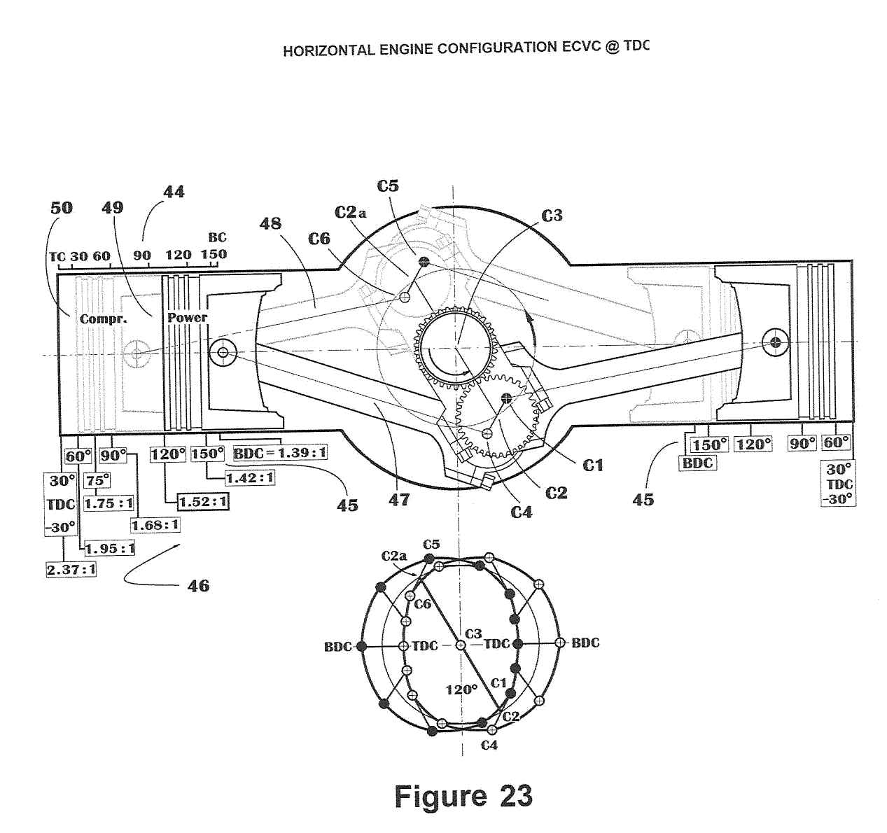

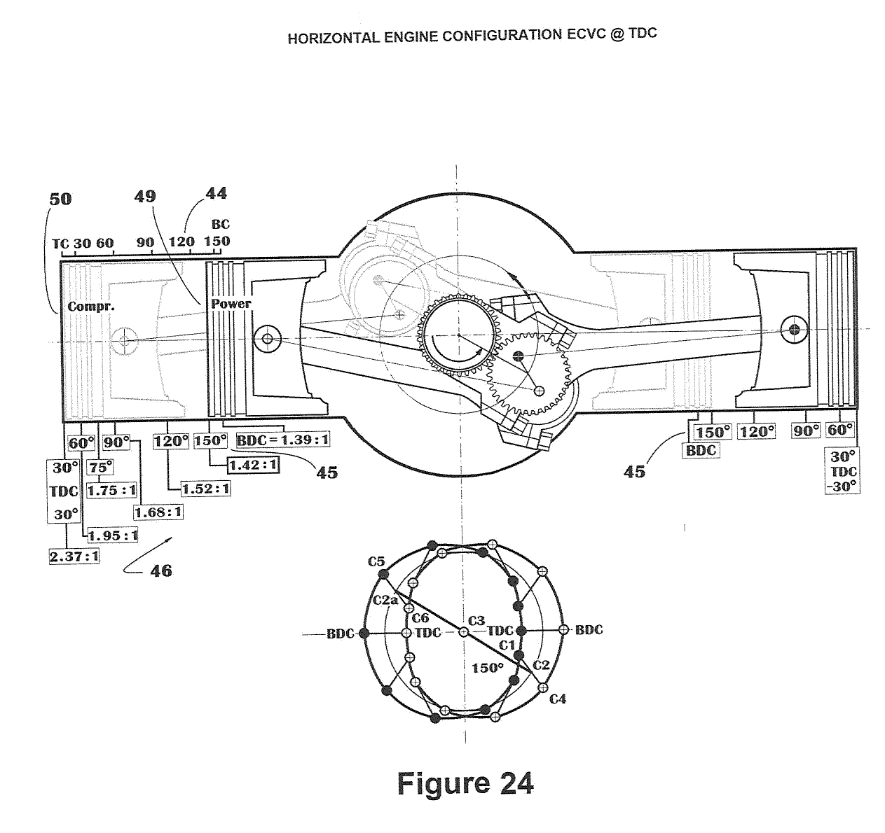

Further the new piston/crank relationship promises higher extraction of the energy and improved power to weight ratio. Fuller combustion at an earlier crank angle promises more silence engine operation and subsequent reduction of exhaust components. The orbital body can have a single orbital journal (pin), shared and opposed orbital journal (pin) 180° on the same orbital shaft to orbit around the revolving and orbital center. Further opposed with another crank arm, the system can be embodied in a four-piston two or four cycle horizontal engine with flat plain arrangement crankshaft. This partially animated horizontal engine model as seen in FIGS. 23 and 24 can be simply coupled to create an eight-piston engine if higher torque is desired.

Orbital pins radially separated for 120° around revolving and orbiting center on revolving and orbital body, further axially separated every 120° via crank arms to employ 2+2+2, V6, 120° cylinders offset, with two or four cycle engine operation. Partial animation of a V6 engine has set EDDUR to appear at TDC point and is meant to show four cycle engine operation.

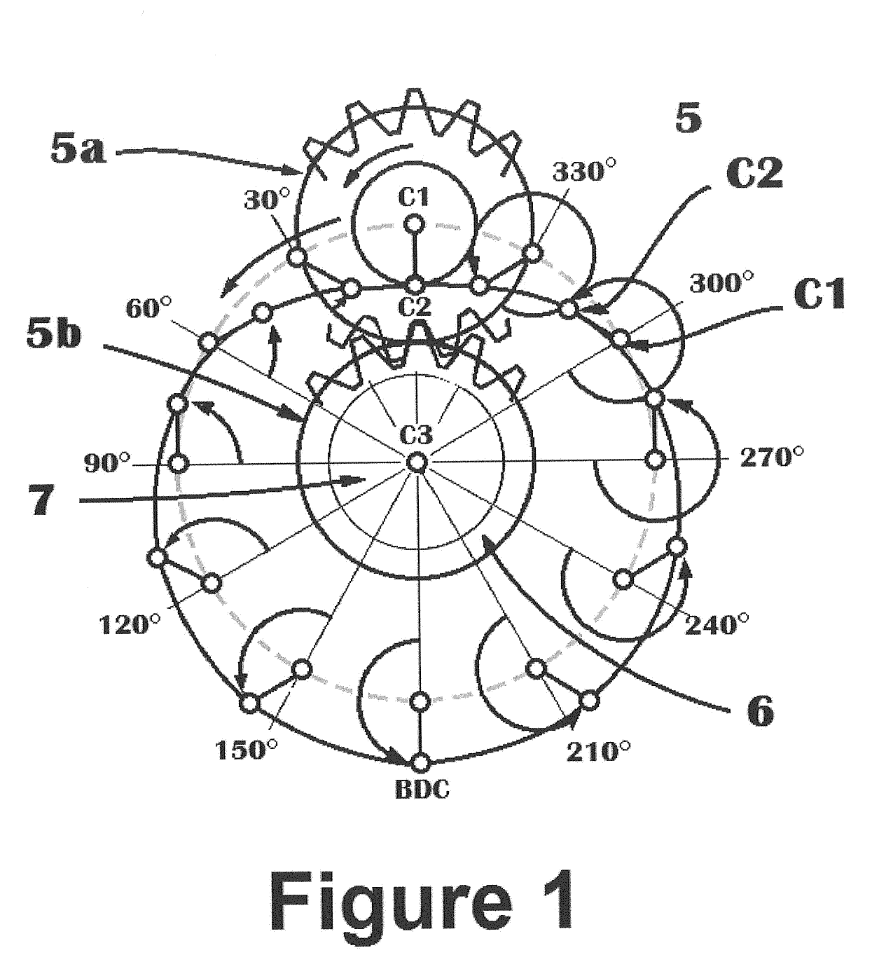

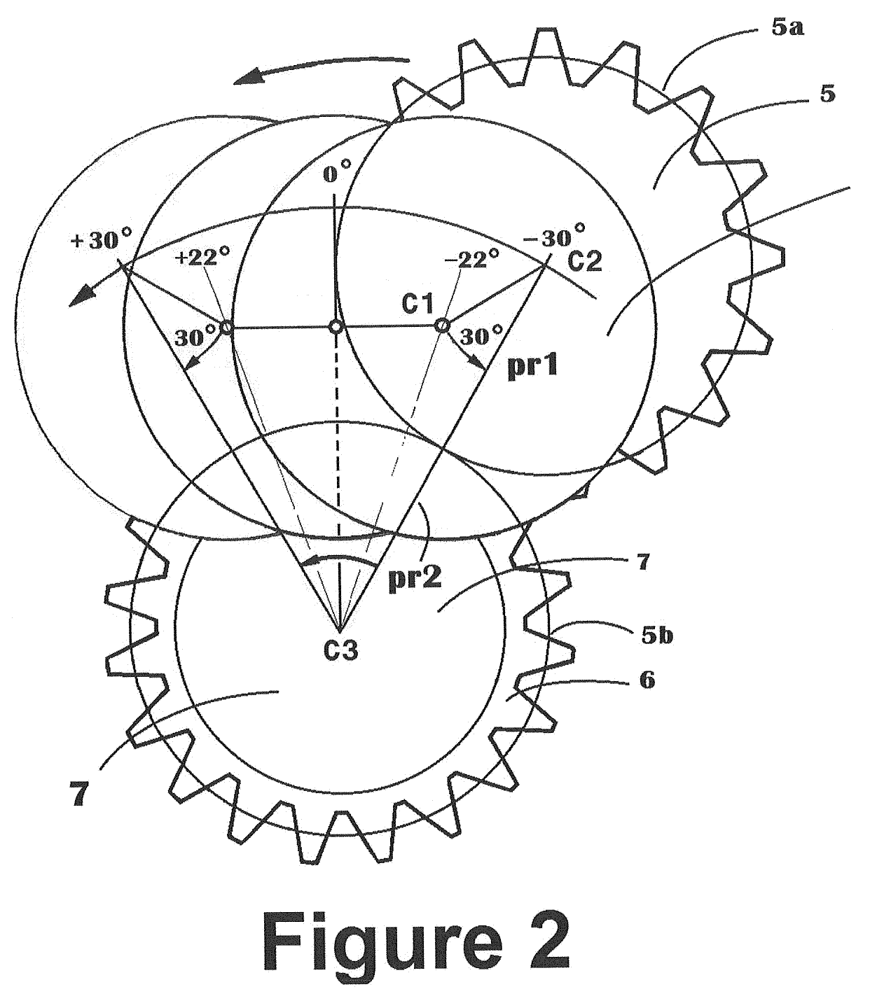

The schematic diagram of FIG. 2 shows a partial epicyclic motion of orbiting rod journal system in accordance with an embodiment of the disclosed principles. As can be seen, this embodiment includes a planetary gear 5 together with an orbital shaft and orbital journal orbits around C2 as revolving and orbital center at a constant distance around the center C3. While C1 simultaneously orbits around revolving and orbiting center following an epicyclic motion around stationary collar sun gear creates an irregular path. The same FIGS. 1, 2 and 3 show how orbital journal with center C1 is offset from the center C2 at distance of 0.52339 of the pitch radius 5a. Starting from 30° bTDC further following epicyclic motion to 30° after TDC can create an almost straight line if coupled with identical stationary sun gear, pitch circle. The crank elements in this embodiment extend the constant volume combustion period cycle (EDDUR) up to 60° of crank time duration.

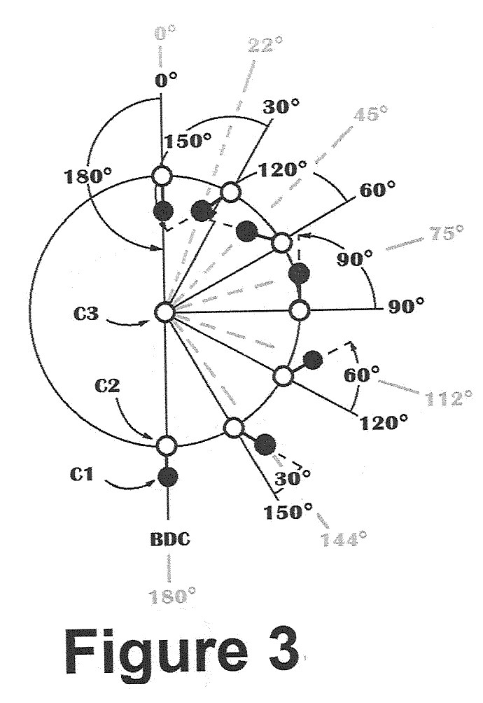

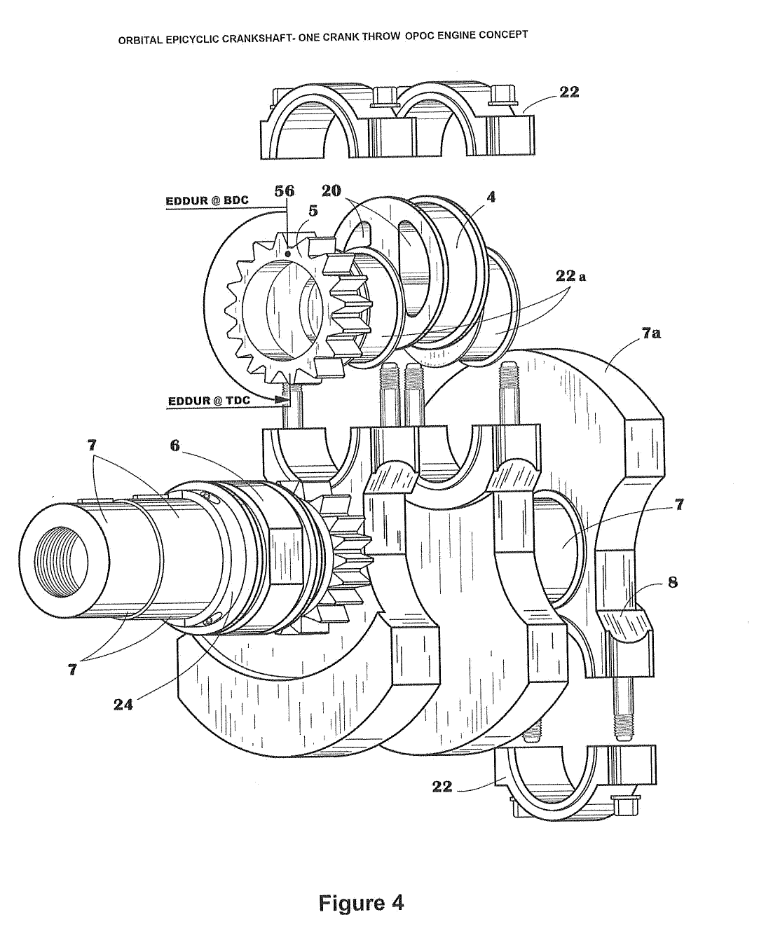

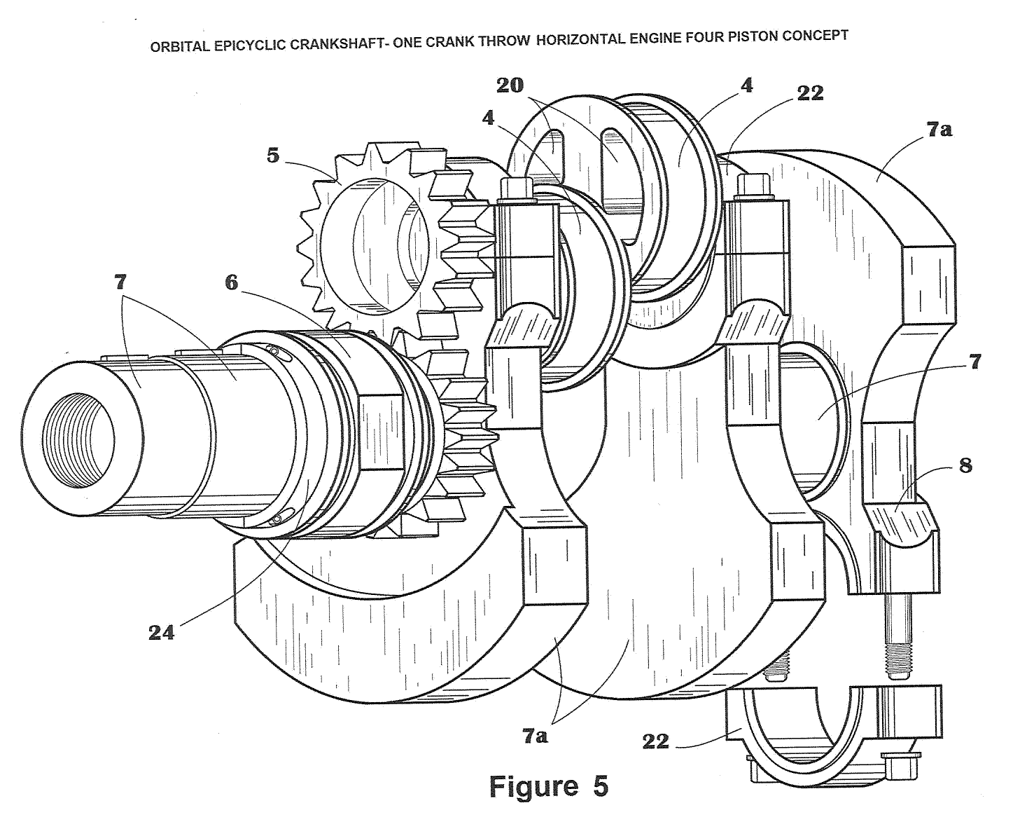

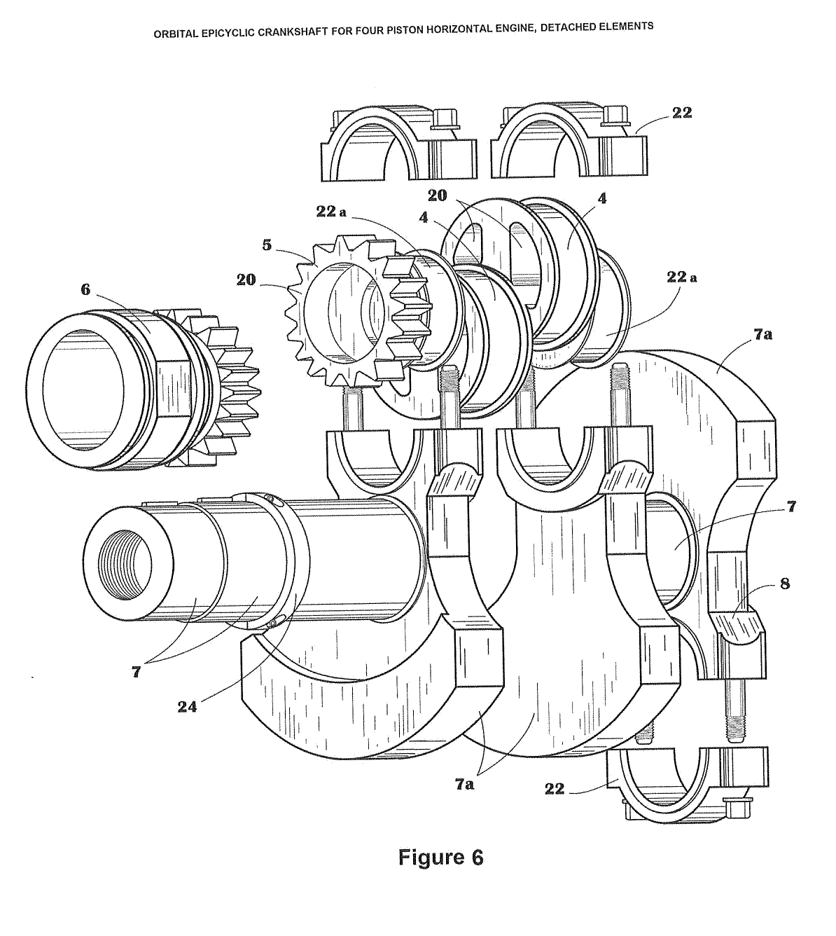

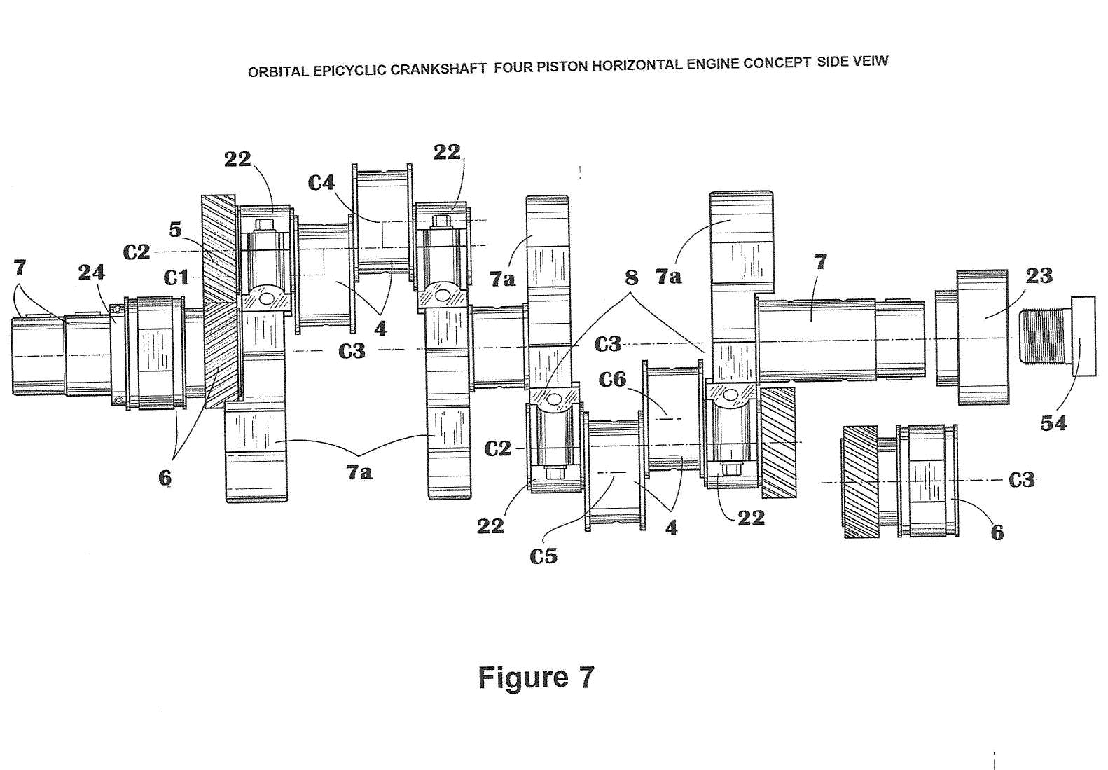

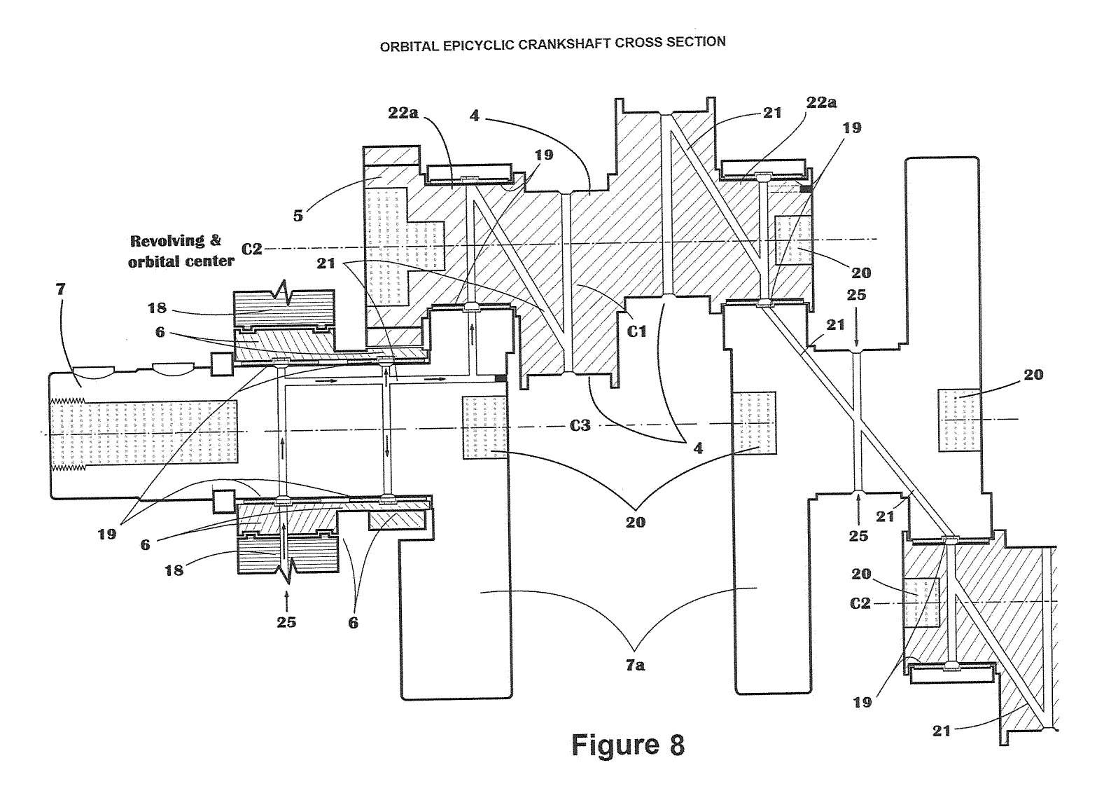

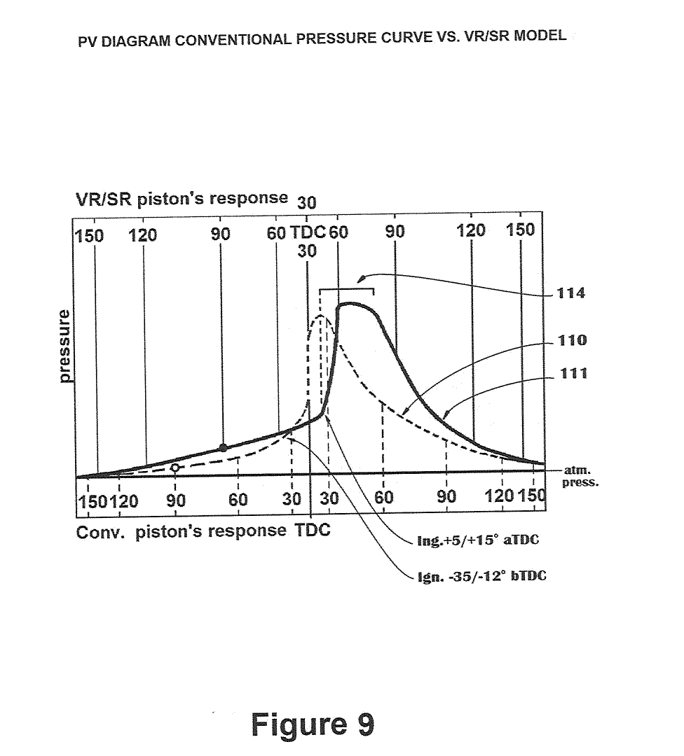

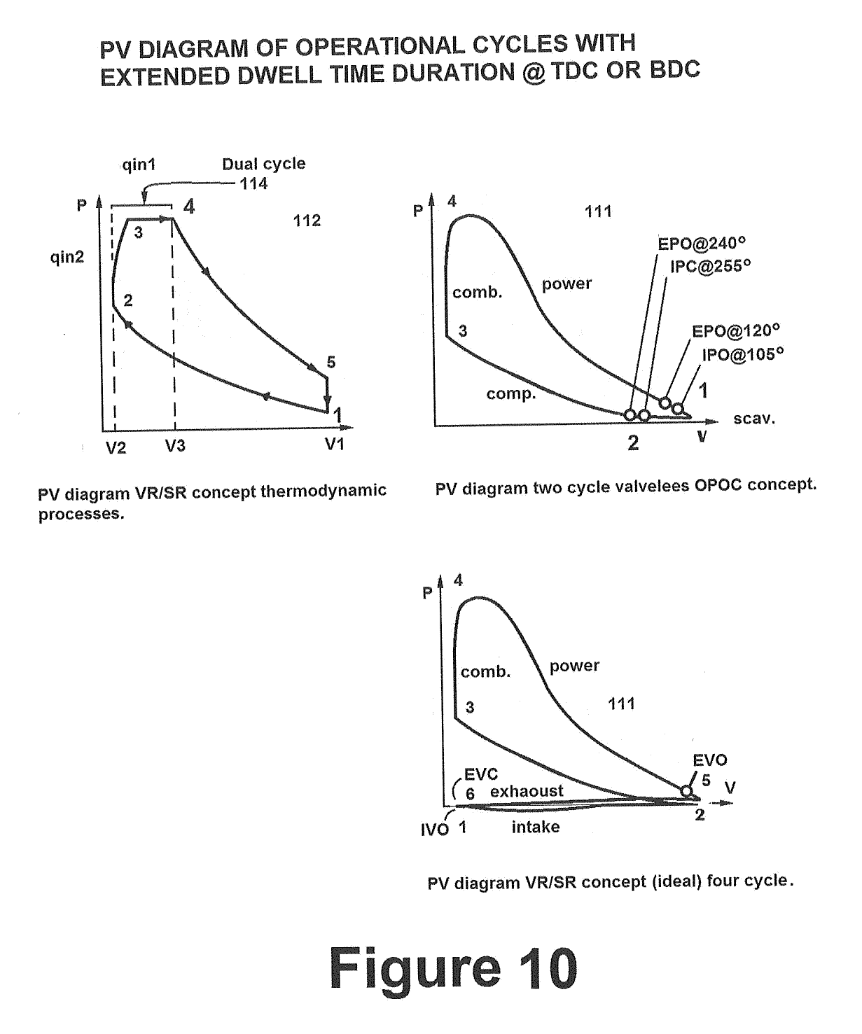

In greater detail of FIG. 3, the geometrical behavior of the orbital pin C1 can be seen in terms of how it is exiting out of circular motion; when the engine revolves, the pin orbits together with planetary gear 5 around C2 position itself at 150° while the C1 is at 144° to the main center of rotation C3. When the planetary gear C2 is at position 120° the orbiting journal C1 will be at 112°. When the C2 is at 90° crank position the C1 will be at 75° to the main center of rotation C3. When a C2 position is 60° the C1 is at 45°. When the C2 is at 30° the C1 will be at 22° to the main center of rotation C3. When the C2 is at 0°, the C1 will be also at 0°, but due to simultaneous orbital and revolving motion (epicyclic motion) positions itself as it rotated for 360° around the main crank journal 7 and C3.

This presented piston to crank mechanical relationship is subject to adjusting depending on the fuel characteristics and the engine efficiency requirements. The epicyclic gear set involves two gears with identical pitch radius and OD. Orbital pin C1 can be set at a greater or lesser distance from the center C2 (orbital shaft 5), directly affecting the piston's response to crank angular motion. For example, reducing the offset distance slightly increases the piston's speed before & after TDC and subsequently decreases the piston's speed before & after BDC, very importantly reduces the constant volume combustion duration. Further, increase C1 offset from C2 beyond this point (disclosed in paragraph 29) will cause the piston to dip toward the main shaft at TDC, momentarily decreasing then again increasing the compression volume and seriously interrupting accumulated angular momentum, simultaneously increases the lateral stress onto the mechanical joints.

The details of comparable animation in between VR/SR concept 111 which lies to the left and conventional 110 are shown to the right. For this demonstration, the planetary gear 5 with a shaft and orbital crank pin is engaged with stationary sun gear (collar style), and the ECVC (EDDUR) appears at TDC to improve four cycle engine operation. Throughout a single and complete epicyclic motion of the engaged gears, the C1 as the center of the orbital crank pin is veering in the distance from main shaft center C2, changing the effective diameter of a the crankshaft. Subsequently, C1 creates and follows an irregular but most importantly vertically symmetric circular path. C1's epicyclic behavior creates VR/SR (variable rod-stroke ratio throughout a single rotation), and the scaler is conveniently displayed on the left side of the cylinder starting at BDC with 1.39:1 and ending at TDC with 2.39:1. Both diameters of the crankshafts can be compared at 75° where the conventional perfect circular path also presented on the model 111 intersects with the irregular circular path (see on the FIGS. 1,3 & 11-22), both models then using the same crank diameter/stroke and length of connecting rod, in accordance with an embodiment of the disclosed principles.

The scalars above the center drafts are horizontally lined and both concepts are animated with 30° rotational increment. This modifies two or four conventional cycles to 150° crank time duration in that it a) creates an ECVC (EDDUR) cycle around TDC & or at BDC with adjustable time duration, b) corrects inadequate piston to crank relationship around TDC or BDC, c) If used in four-cycle concept, provides ECVC cycle in between exhaust and intake cycle where the intake valve could open @ 30 before TDC improving volumetric efficiency by forced induction, d) creates a dynamic compression cycle of ⅙ shorter than conventional piston-crank time duration thus qualifies the concept as extra durable on knocking phenomena, e) creates an ECVC cycle (EDDUR) @ TDC in between compression and power strokes for better control of the charge where the intake valve can open at 30° bTDC to extend pumping time duration to 210°, slightly improving volumetric efficiency in the case of forced induction, and f) In the case of setting of an ECVC cycle to appear at BDC point enlarges scavenging time of the port induction concepts to 120°.

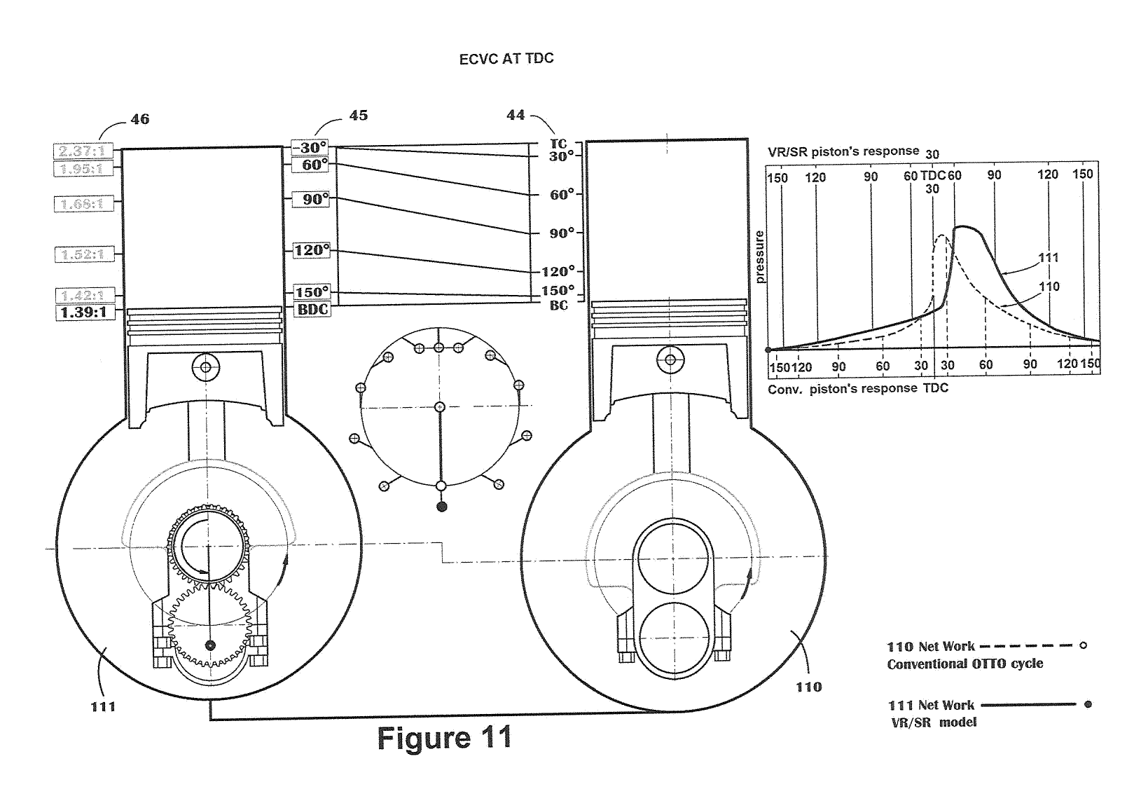

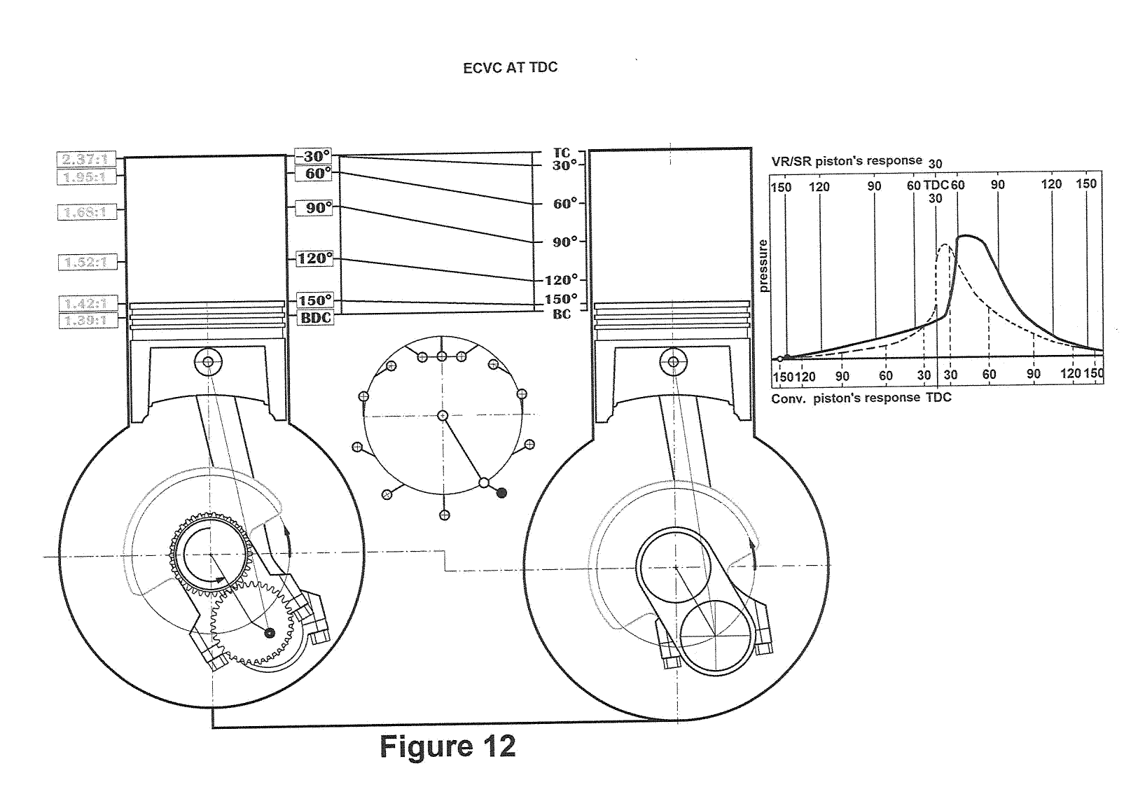

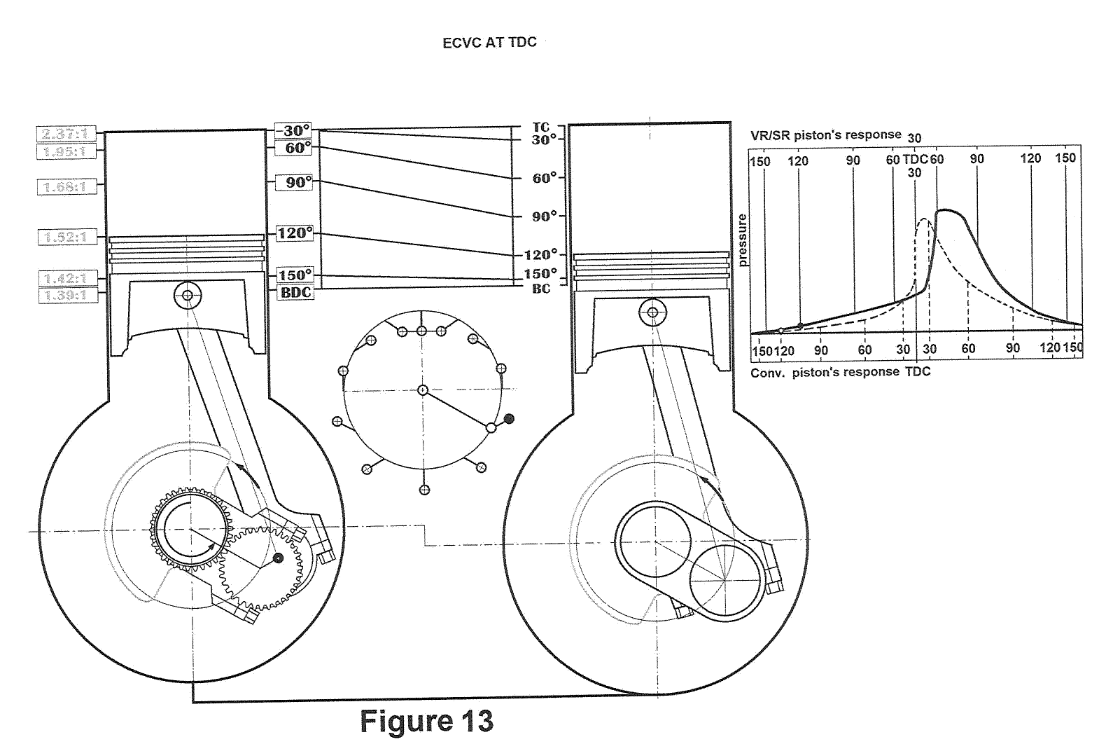

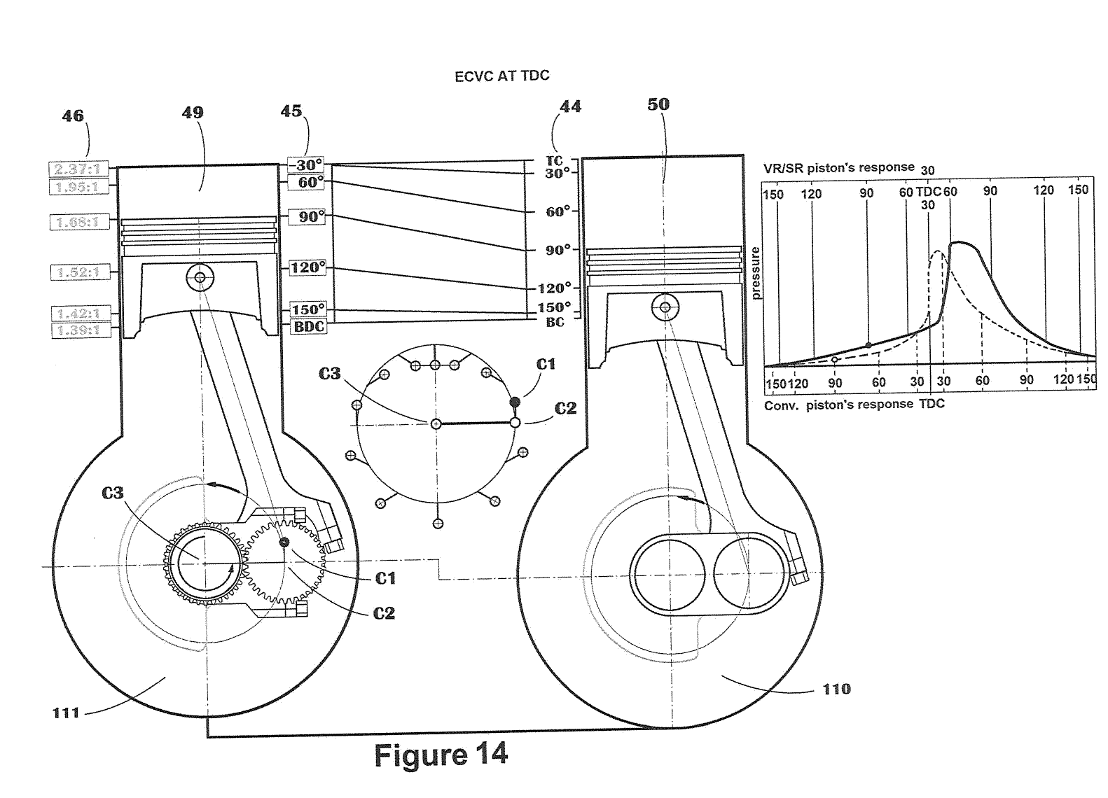

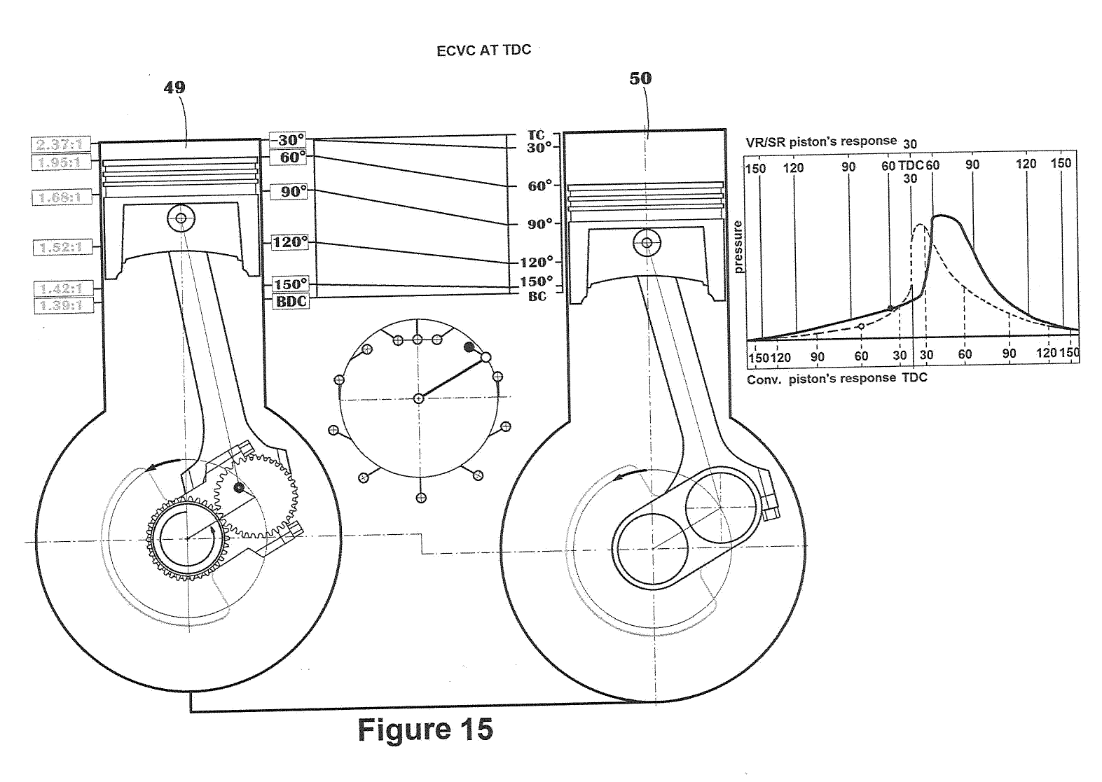

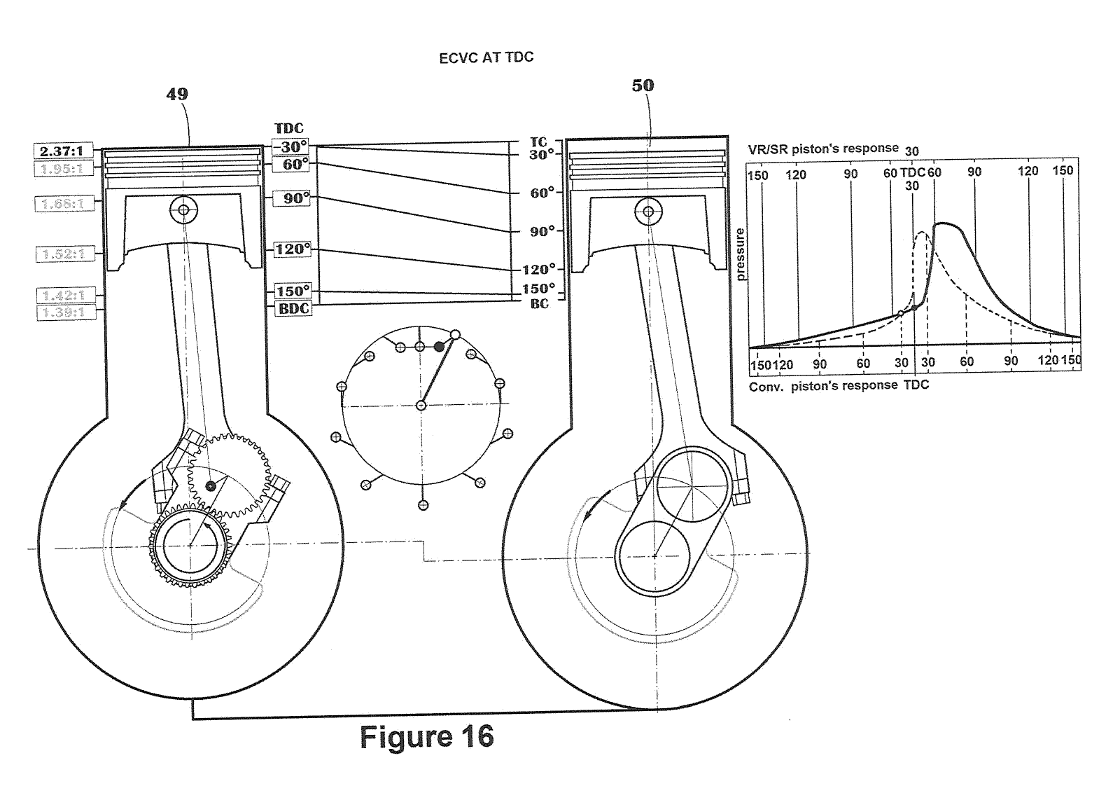

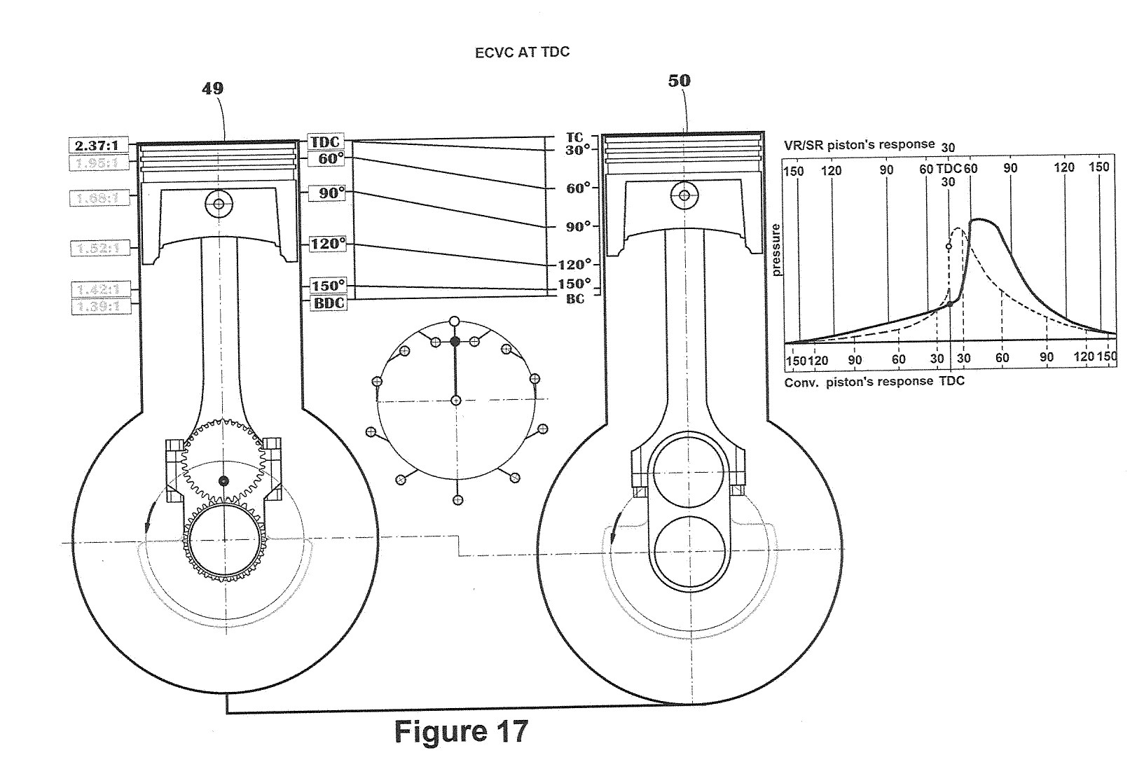

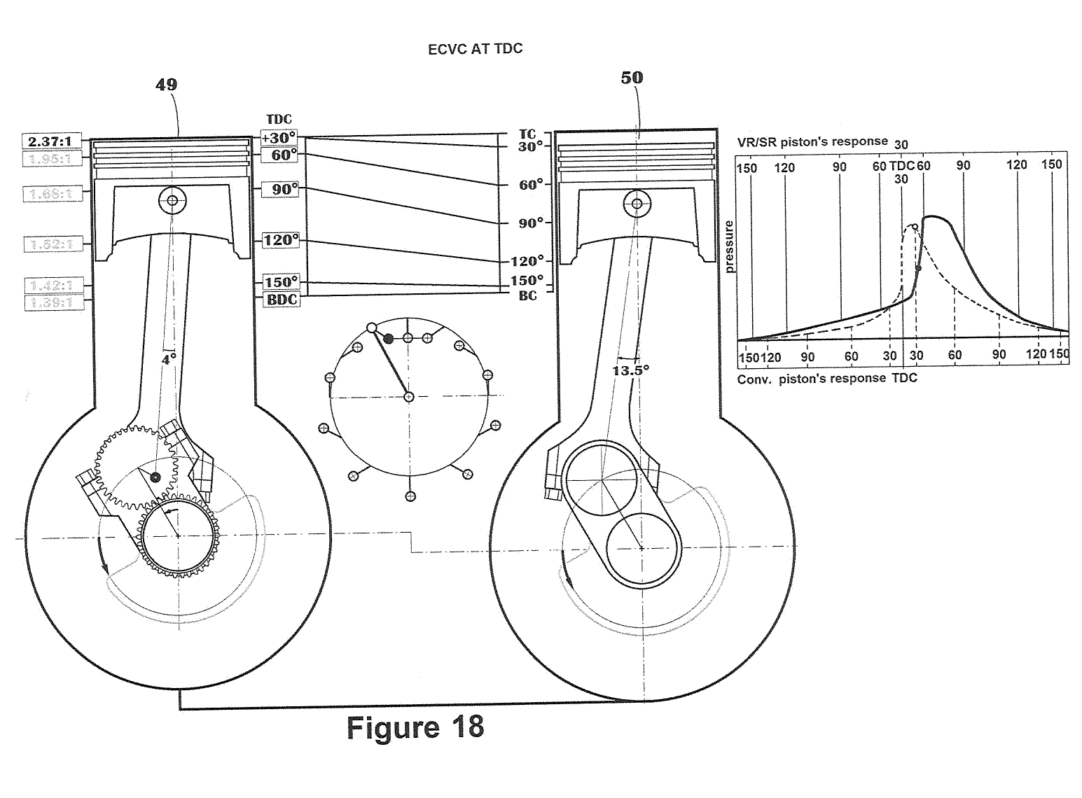

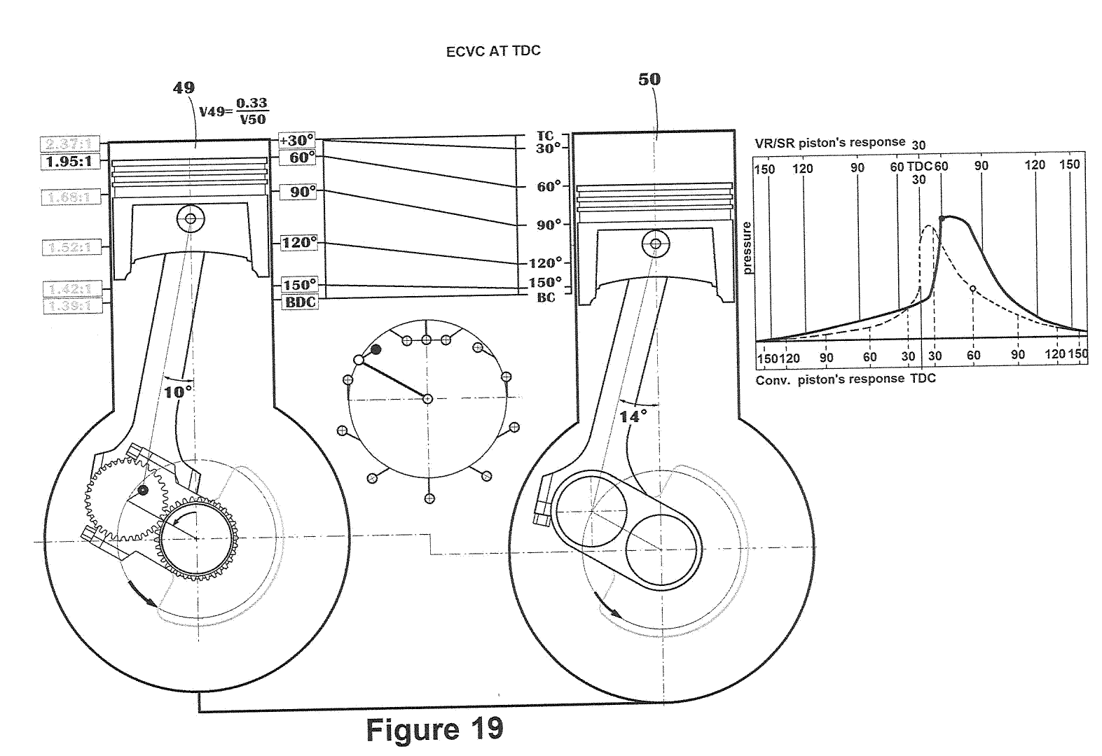

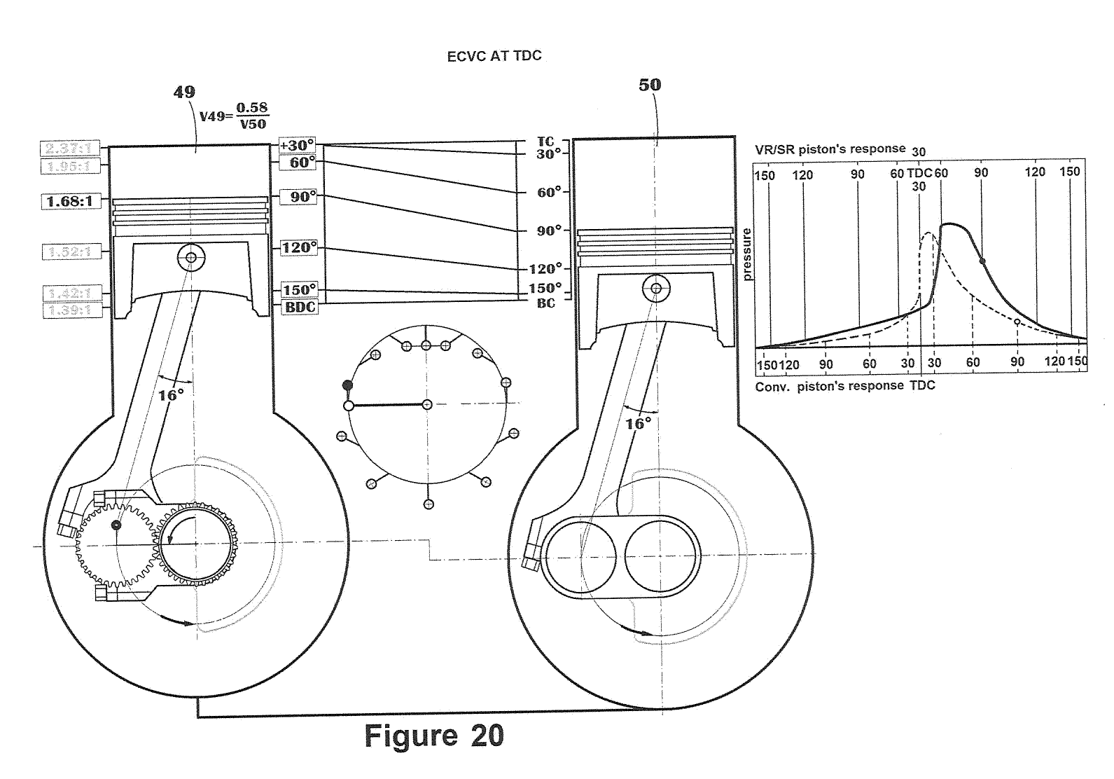

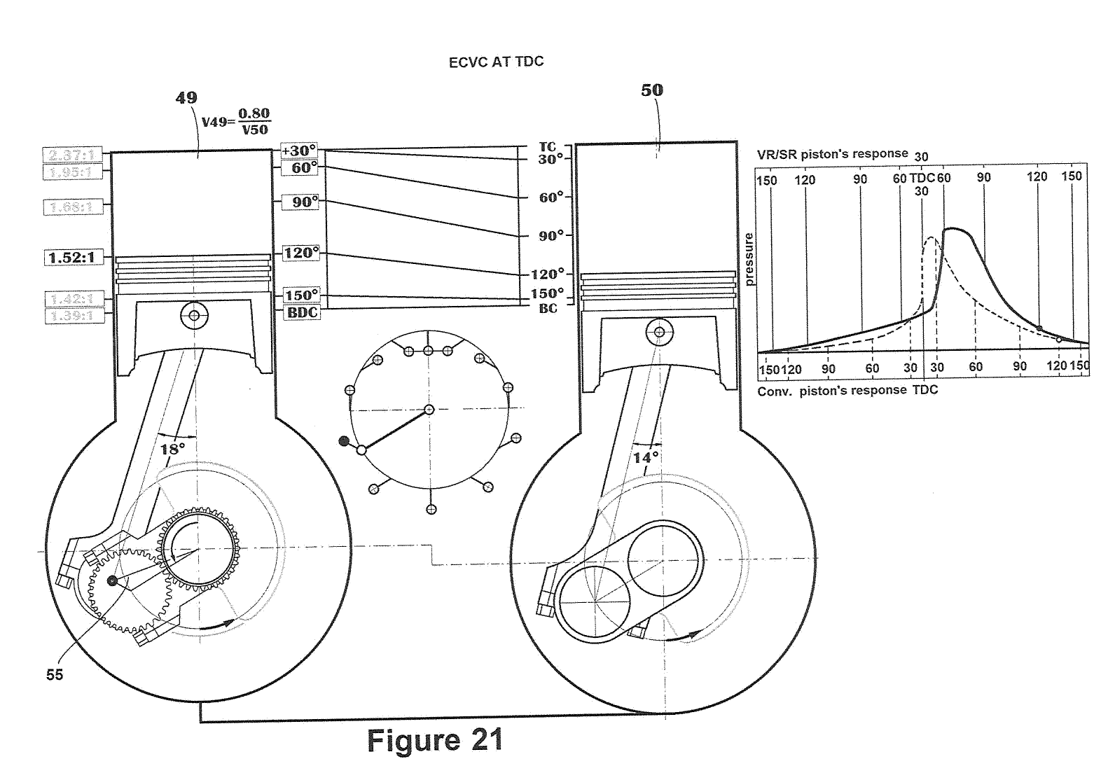

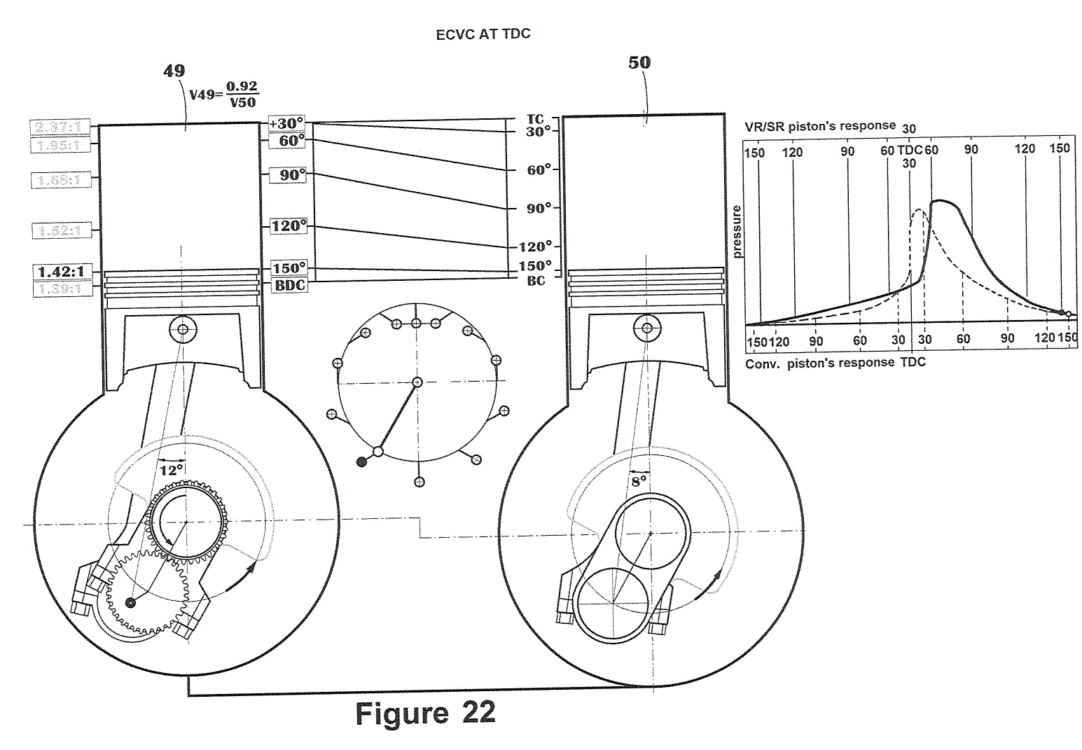

The system for four cycle engine operation as seen in FIGS. 11-22, VR/SR model at 60° provides volumetric displacement only 0.33:1 vs. conventional, further at 90° only 0.58:1 and at 120° devalues the pressure 0.80:1, at 150° still lower at 0.95:1.

Turning to FIGS. 23 and 24, a horizontal four piston concept with VR/SR operation is shown. This figure shows the operation of a horizontal engine embodiment with a new layout of the regrouped pistons involved in reciprocating motion. Opposed orbital journals horizontally used in flat plane fashion still keep all mechanical elements in an inherently balanced position. Two or more such assemblies may be stacked to employ a higher number of cylinders. The same figure has omitted the positions of counterweights for clarity of the draft. Contents of the figure are; Variable rod to stroke ratio scaler related to specific crank angular motion 46, connecting rod and piston at 120° in expansion cycle 47, volume and cylinder pressure created with new mechanical engagement versus conventional model with scaler above the left cylinder 49, connecting rod and piston of compression stroke 48. The image shows the higher level of the compression stage achieved under volume 50 while the power piston is holding lower volume under 49 equal to 0.80 of volume 50. Due to slower volumetric increase from 30° aft. TDC to at least 105°, more time is given for better fuel propagation and a higher level of atomization. Cylinder pressure at this piston and crank position is at least a 25% greater value.

FIG. 24 emphasizes only one position of crankshaft while the engine is finishing the compression cycle. Further, the specific position of the crank elements demonstrates how it doesn't require a lot of force to keep the charge in a mechanically entrapped position in cylinder 48 for two reasons: a) the charge hasn't been ignited so the pressure in the chamber is lower at this particular position, and b) the unique mechanical engagement of the elements maintains low crank arm and rod angle throughout the ECVC cycle, thus requiring less flywheel torque at this angle of engine operation.

Accordingly, as it doesn't rely on flywheel torque to complete the compression stroke, the construction of the crankshaft can be lighter. Unlike the prior art, an epicyclic crankshaft while in operation creates and recovers a new source of energy. Thus far, such an orbital momentum hasn't been mentioned and studied with respect to ICE. In this embodiment, it is expected that orbital momentum will act cooperatively with angular momentum since the vector of the forces has the same direction. Further, the new form of accumulated energy herein angular momentum will fill in the large power gaps that appear in the conventional model throughout operational cycles and support the concept while compressing a charge.

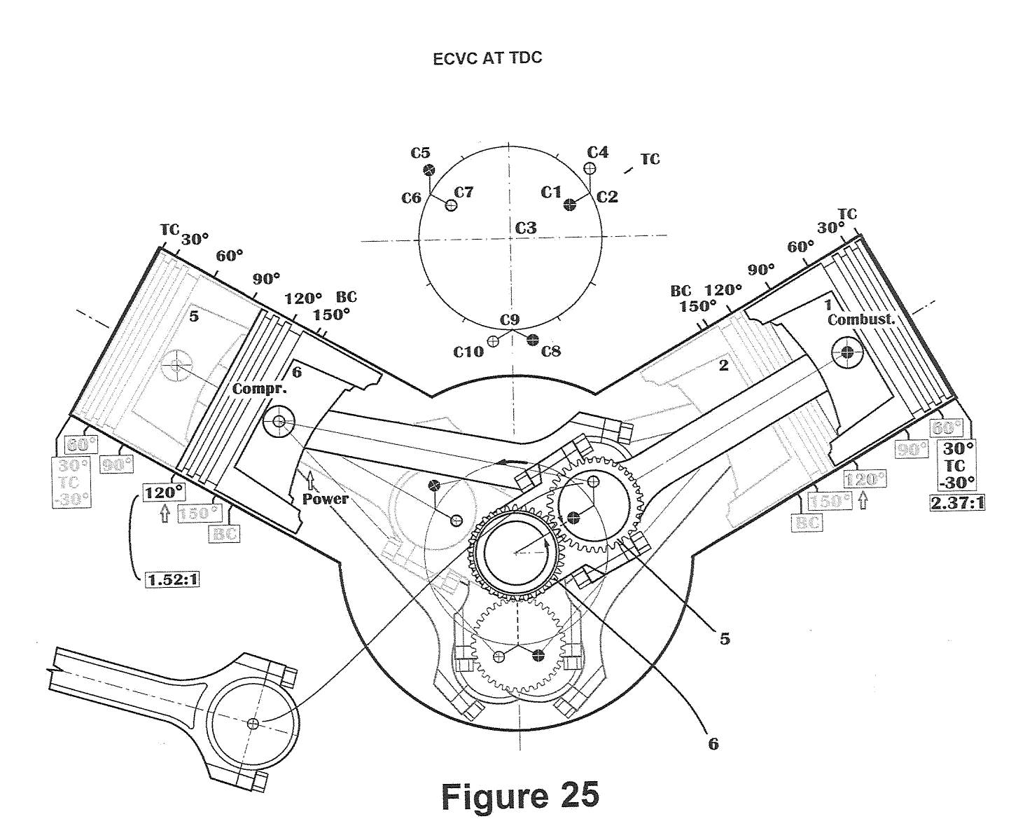

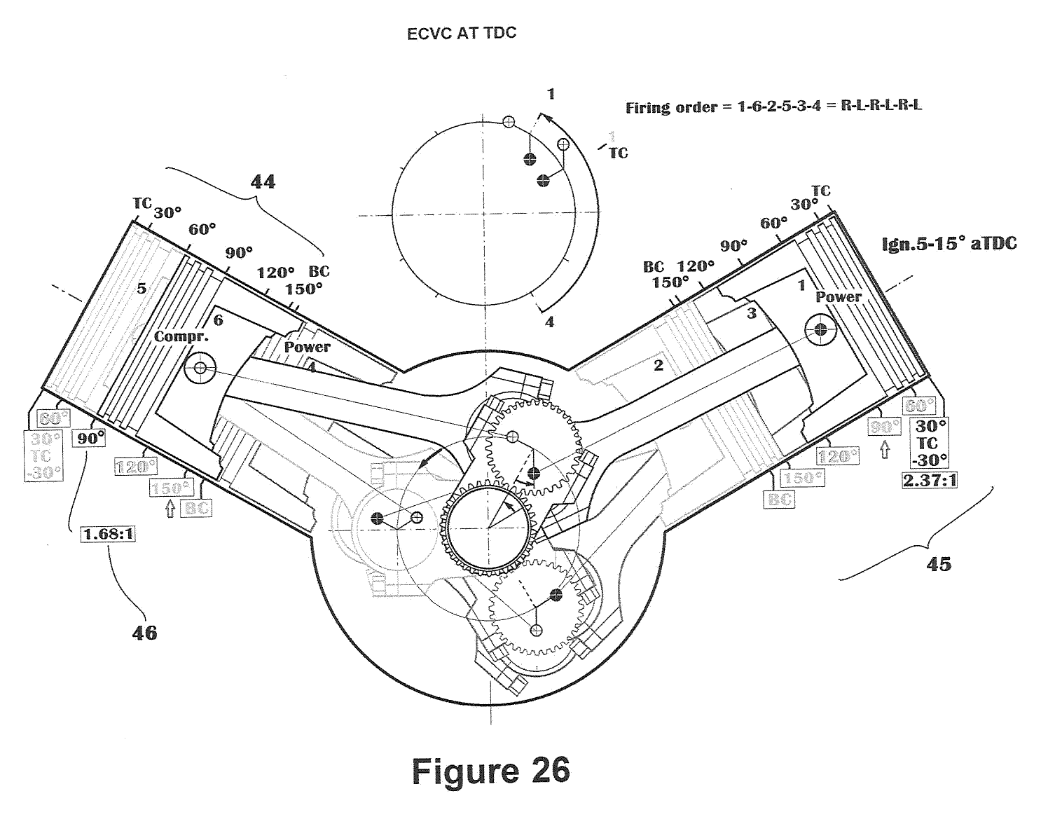

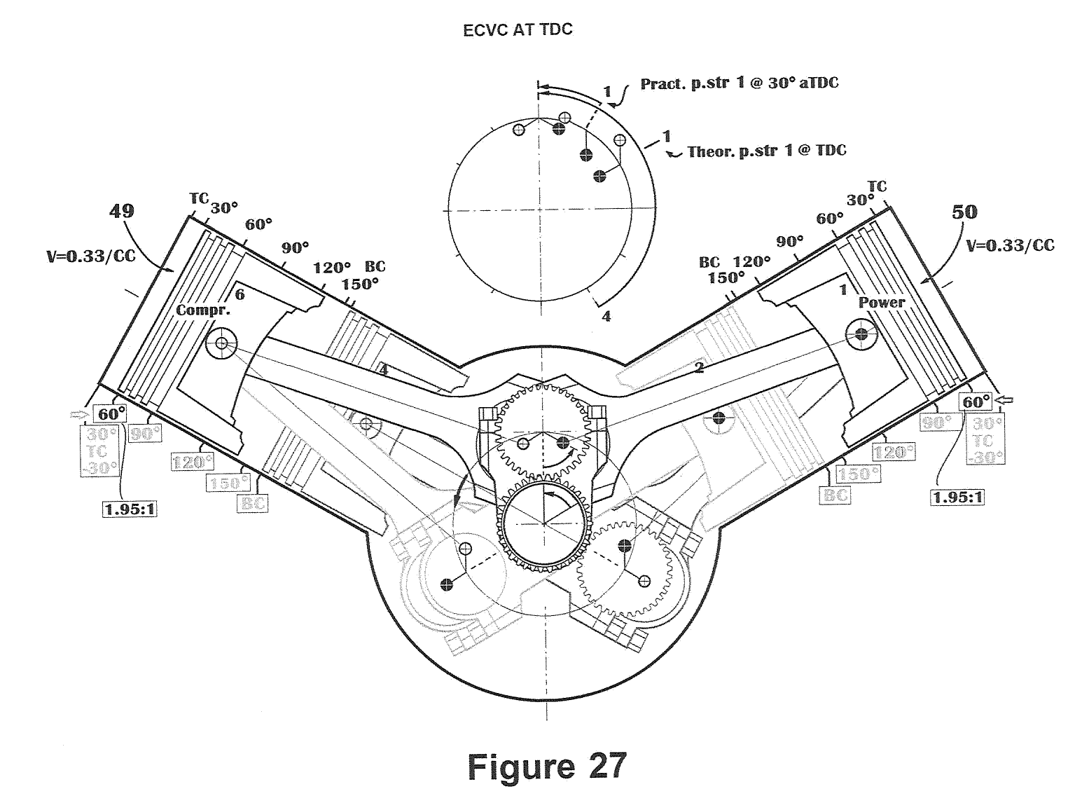

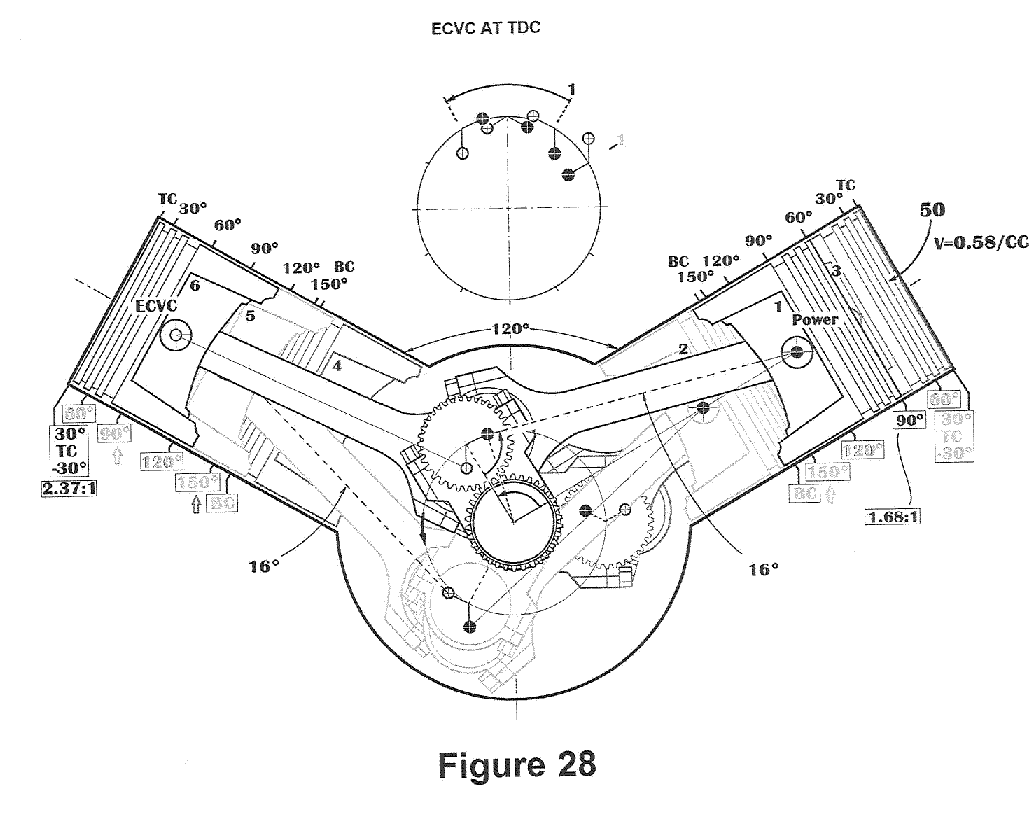

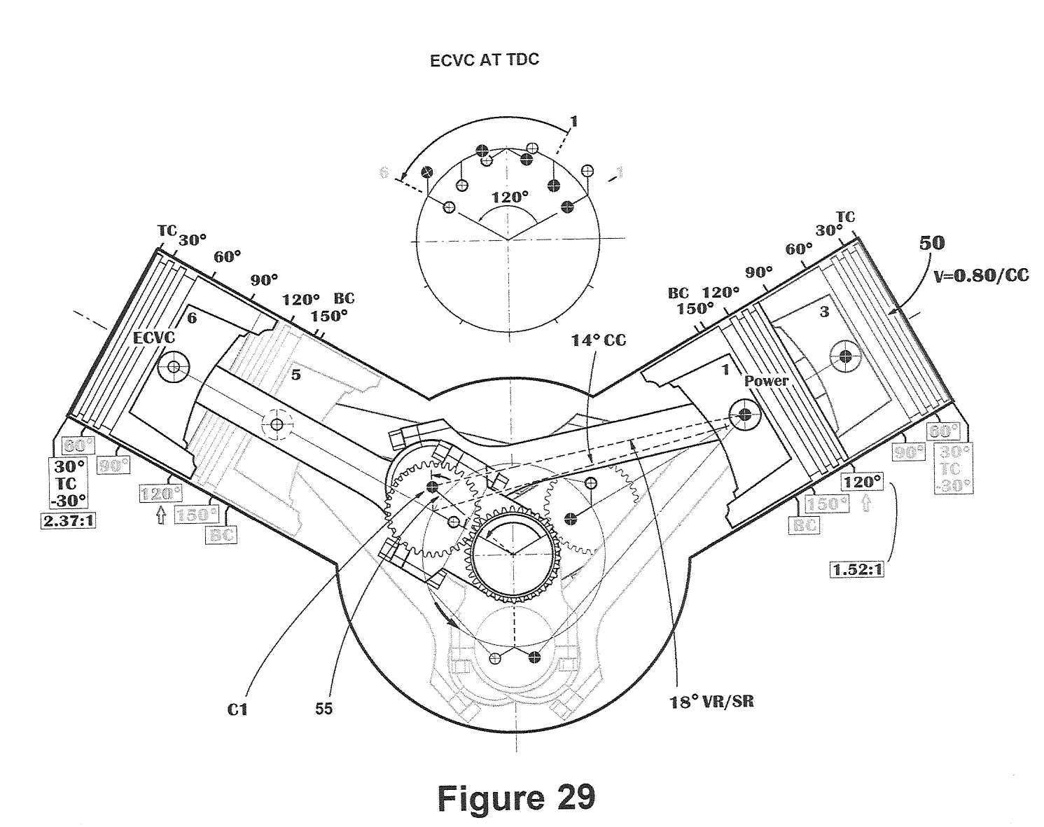

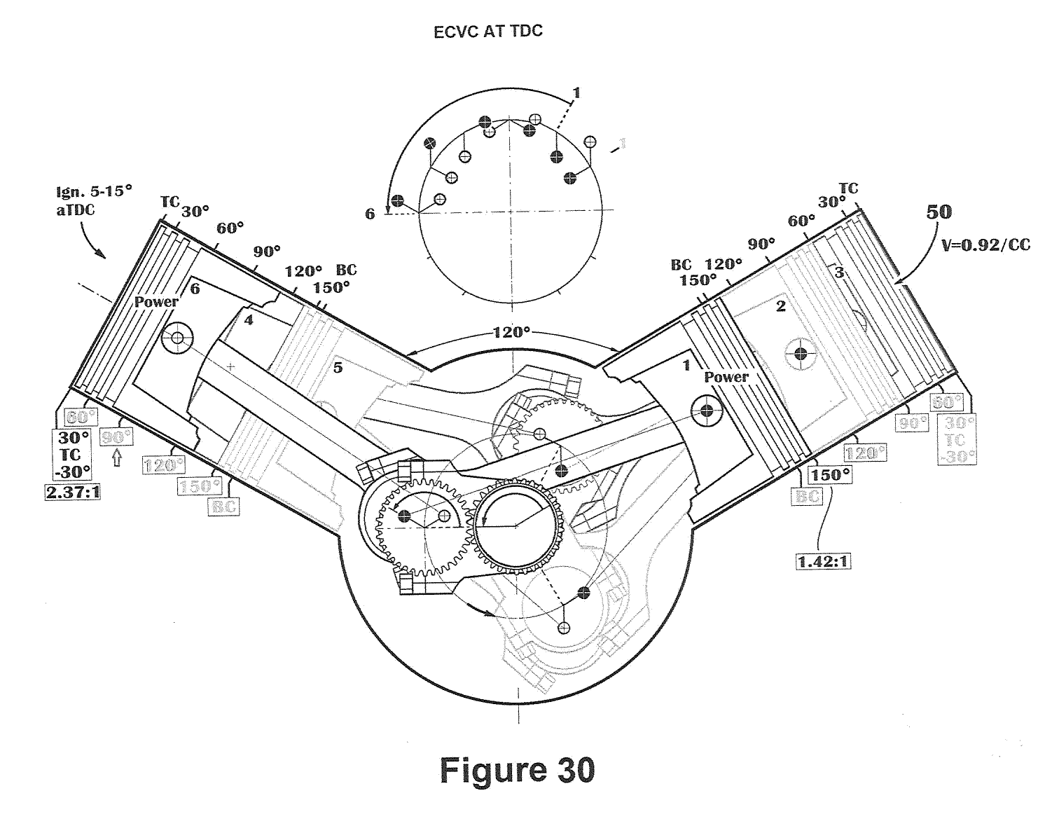

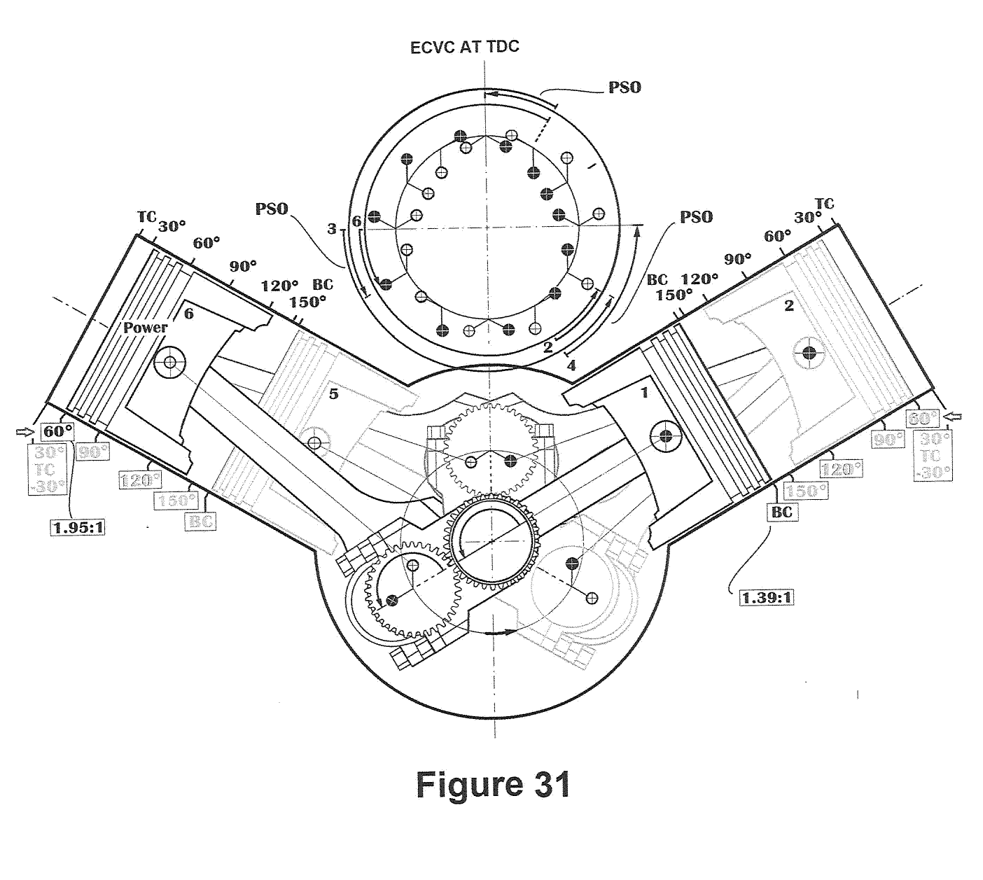

Turning to FIGS. 25-31 with more detail of the operation of the Zivkovich cycle. The figures are presenting a schematic illustration and partial animation of an epicyclic crankshaft in V120° engine configuration in accordance with an embodiment of the disclosed principles. The ECVC is mechanically set to appear at TDC for four-cycle concepts operation. Crank arms and orbital shafts are radially and axially offset at 120° around the main center of rotation C3. Orbital pins are similarly radially offset at 120° around revolving and orbiting center C2 (the center of one orbital shaft), C6, and C9 seen in FIG. 24. The animation has transparent cylinder walls in order to visually present the ability to create a crankshaft for a “V” engine configuration with these specific crank elements.

The valve controlling system and all other elements are omitted for clarity. The firing order of the engine starting from cylinder 1, as the first cylinder on the right side towards the front of the engine, further following the counter clock rotation since this animation exercises left crank rotation, is R-L-R-L-R-L or 1-6-2-5-3-4. The figure is meant to focus on the piston's volumetric displacement with crank position. The scale above the cylinders 44 is from a comparable conventional engine using a square bore-stroke ratio and equal 1.75:1 rod to stroke ratio. At the bottom of the cylinders is shown a scaler of the VR/SR concept's volumetric displacement throughout operation of an epicyclic crankshaft 45. A slightly less crucial detail of this animation is #46 which presents a particular crank diameter as an epicyclic crank operates and is VR/SR rating. The animation shows a partial animation of operational cycles, wherein piston 1 which is performing the expansion cycle versus corresponding piston 2 on the left side which is in the compression cycle. New piston to crank relationship engages the piston to move very slowly after the conventional TDC point, thus allowing the ignition to take place at 5°-15° after the conventional TDC point.

The figure clearly shows how cylinder 1 based on specific volume after TDC point up until 105° is in a totally advanced position with cylinder pressure vs. conventional model. For instance the volume at 60° of VR/SR cylinder 1 under scaler (45) is equal to 0.33:1 vs. conv. mode (44), which directly sets the pressure at three times higher rating, if equally managed. Further registered volume at 90° of the same power stroke in the cylinder 1 is equal to 0.58:1 vs. 44 scaler rating and the cylinder pressure is expected to be about twice higher than the prior art mode. According to another kinematic of the V120° epicyclic crankshaft demonstrated in this animation; while the piston 1 is at its own 90° with noticeable higher cylinder pressure at this state of power stroke, the piston in cylinder 2 is already in the ECVC cycle.

A mechanical and geometrically-locked in position of the orbital pin center C1 does not require much mechanical force to stay in the ECVC cycle. Therefore the VR/SR model saves that unused energy in the form of angular and orbital momentum and creates an overlapped power stroke of 30° with the power stroke of piston 2. The VR/SR model further provides radially overlapped power strokes every 120° of the epicyclic crankshaft motion. The detail sketch shows the V6 animation labeled as OPS. Observing the animated figures further, it is visually noticeable that all revolving, orbital and reciprocating crank elements are in constant inherently balanced position. The setting of the epicyclic crank elements used in this animation can be seen in the FIGS. 11-22. Due to reversed piston speed of the concept rocking effect is minimized; first order force is balanced (synchronized) by having radially overlapped power strokes. The crank diameter of both concepts are the same and could be compared at 75° of both crank positions where the irregular VR/SR path intersects with conventional perfect circular path. This animation has omitted the presence of counterweights for better visual access to other opposed crank arms and opposed orbital shafts.

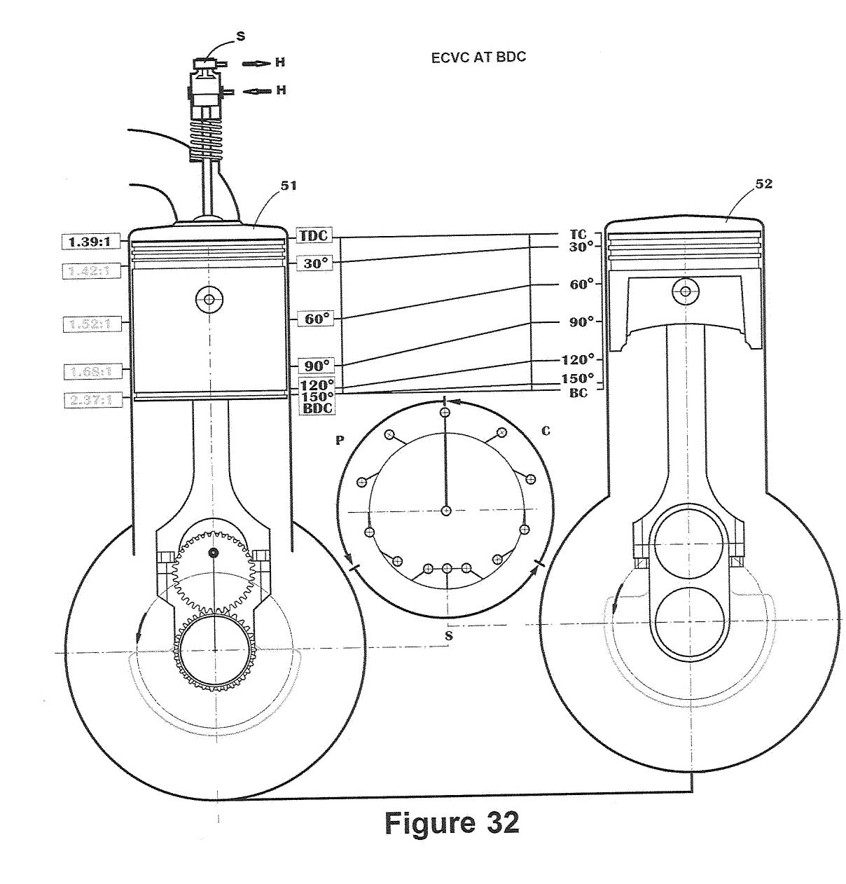

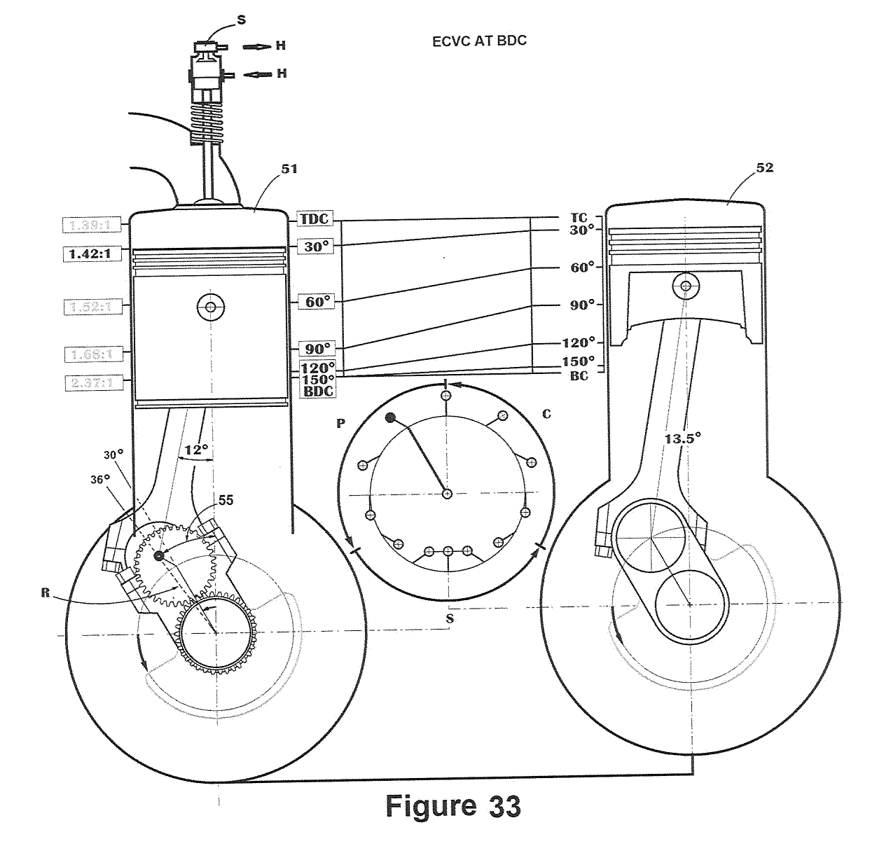

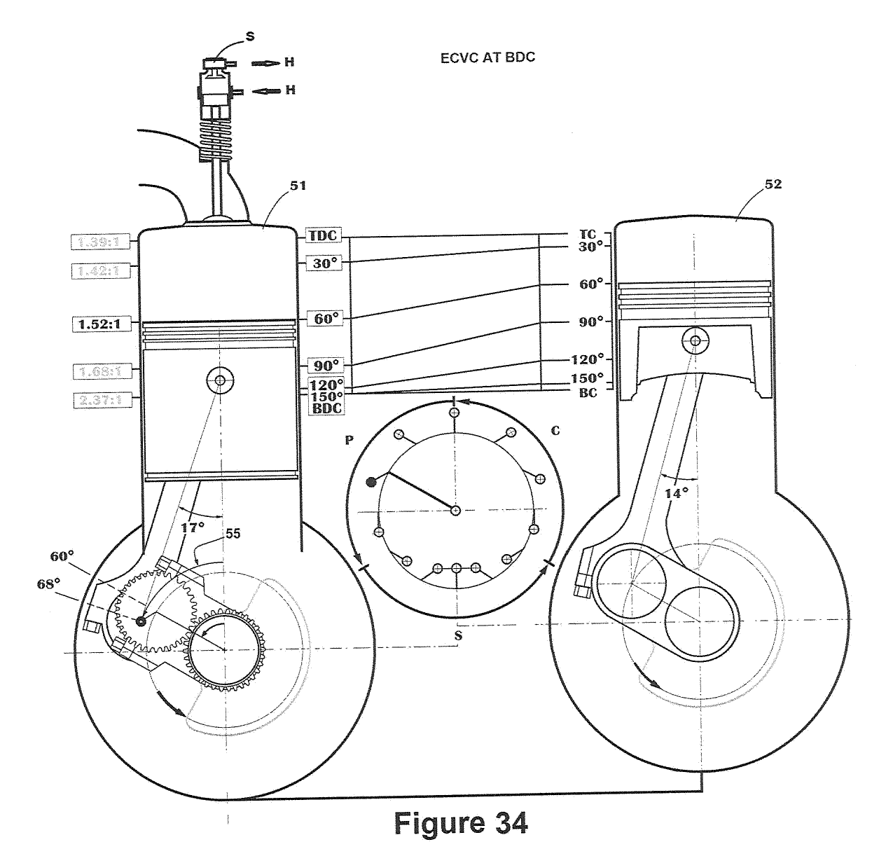

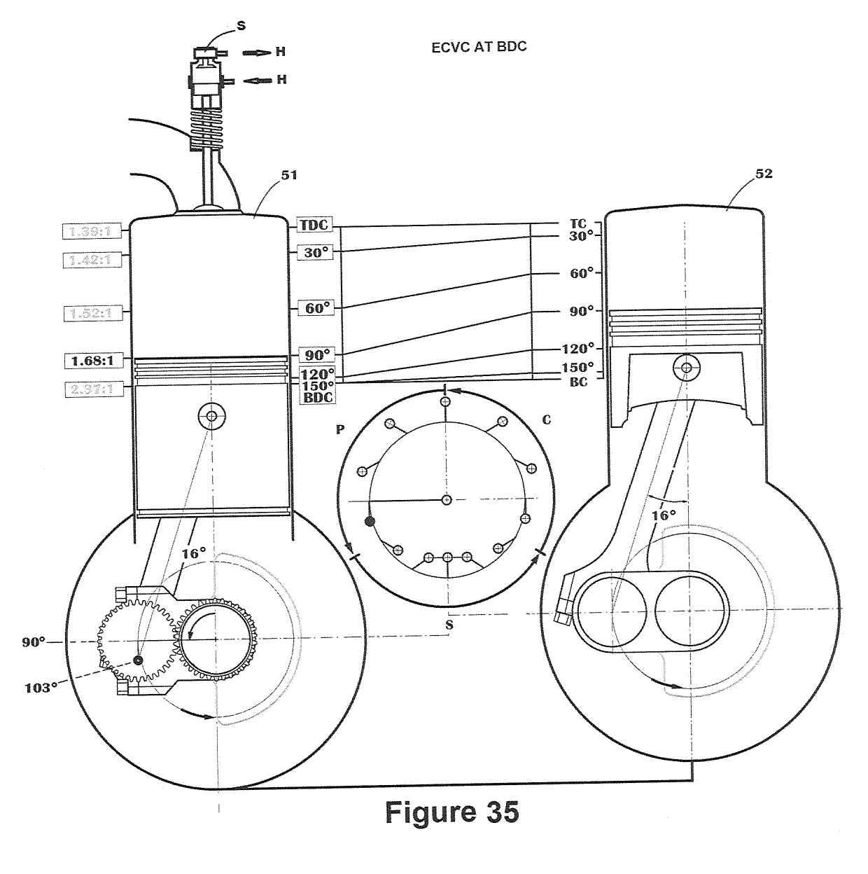

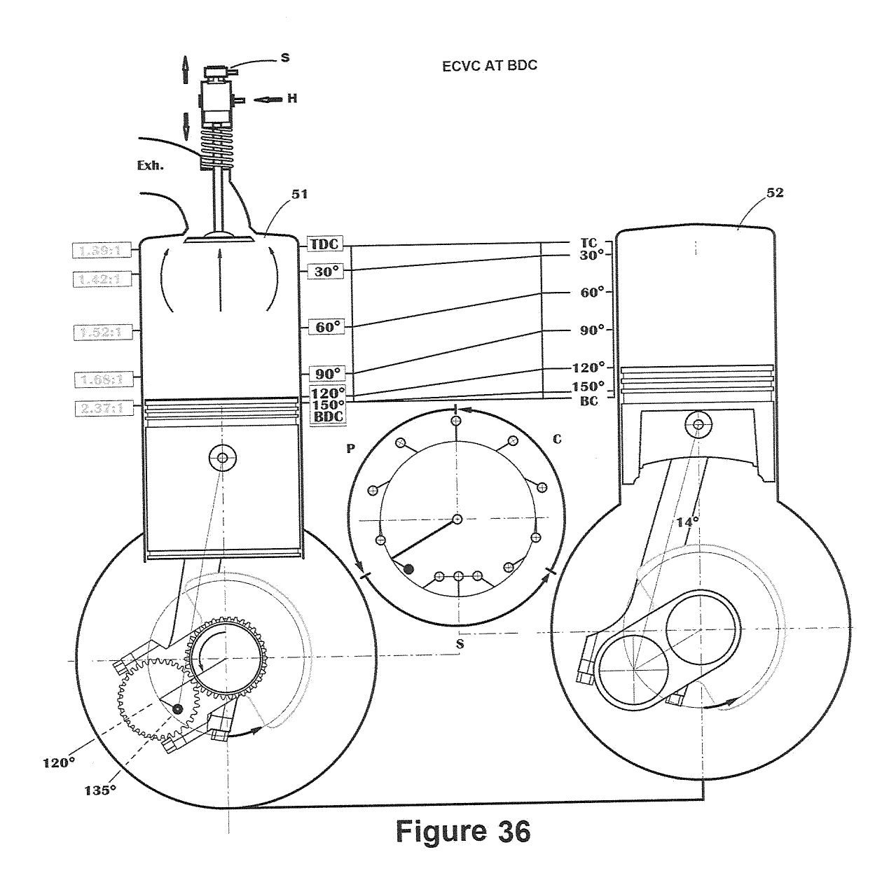

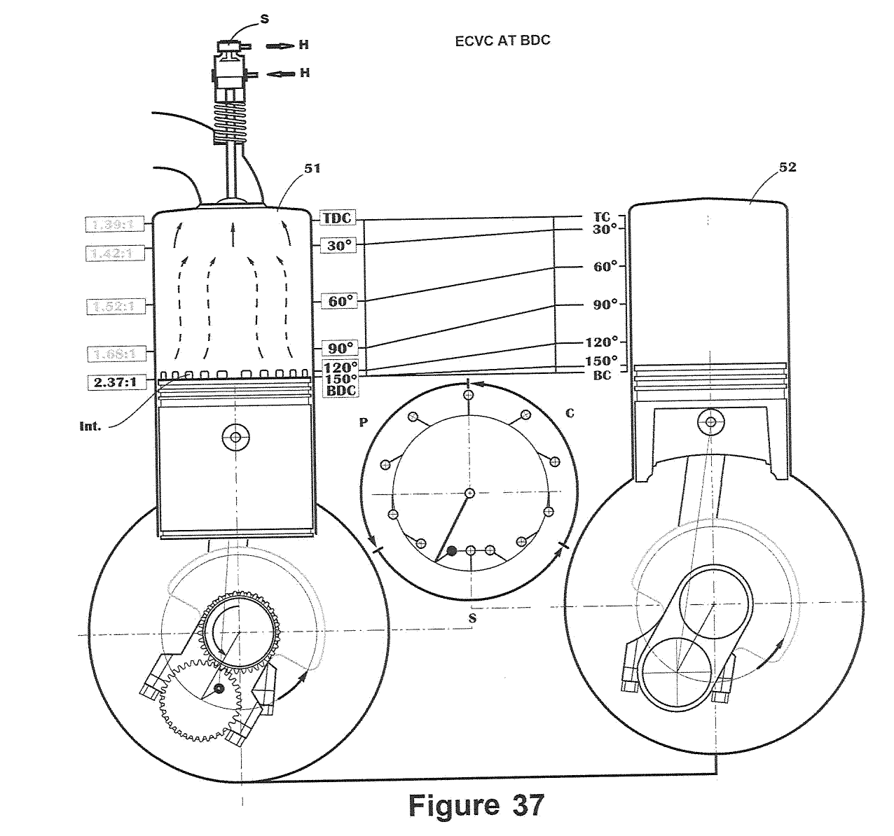

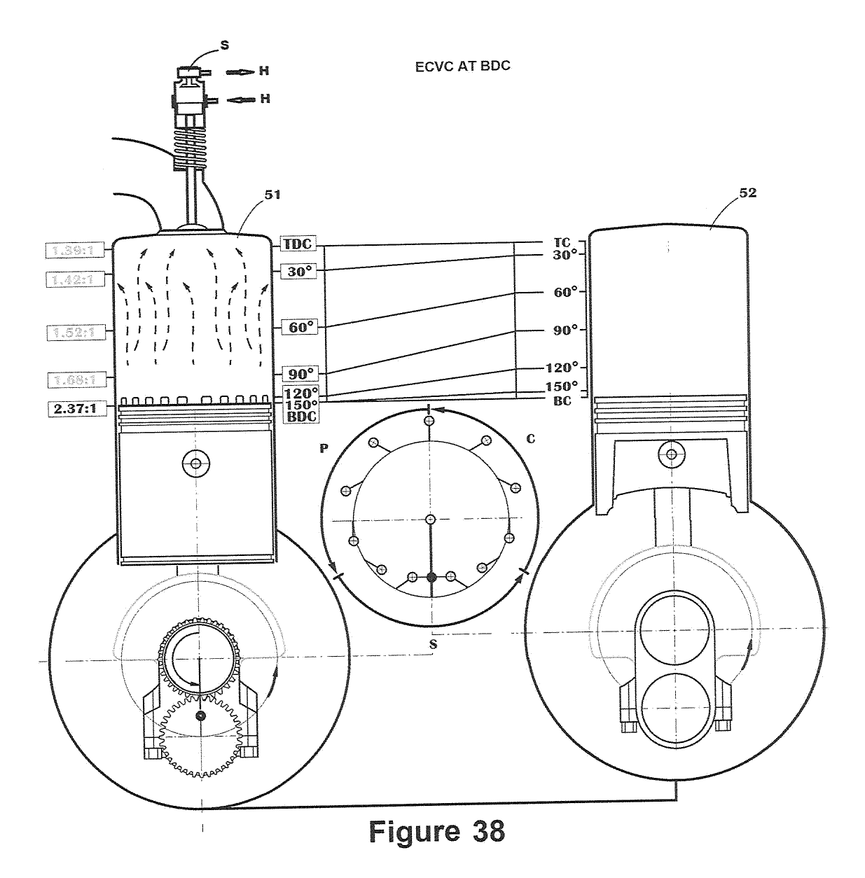

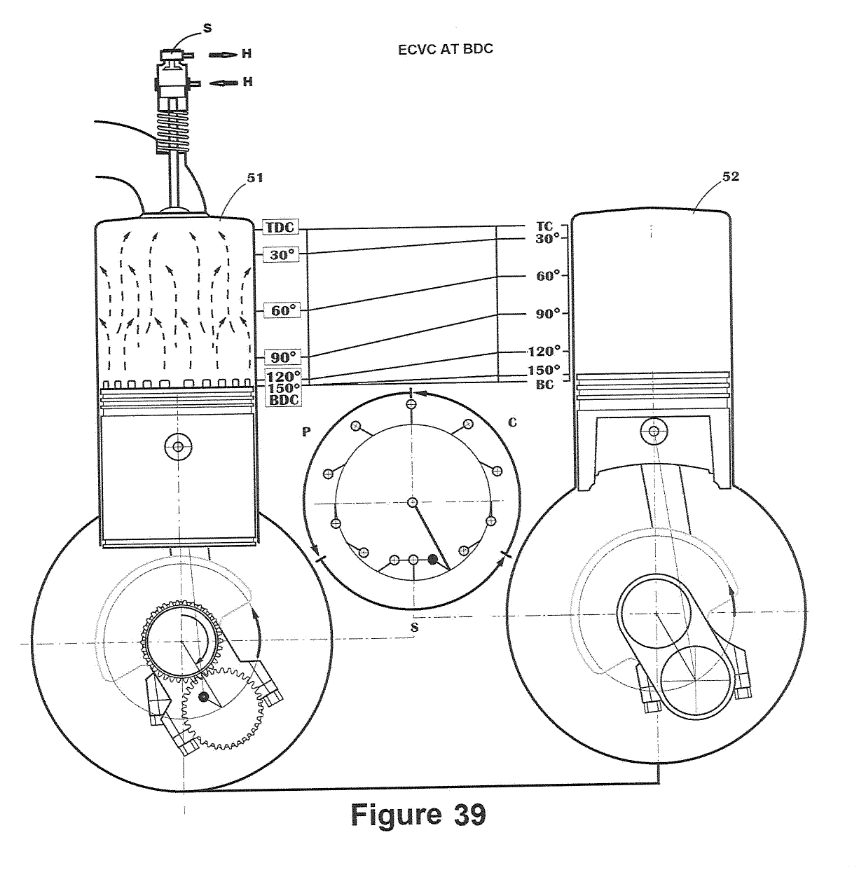

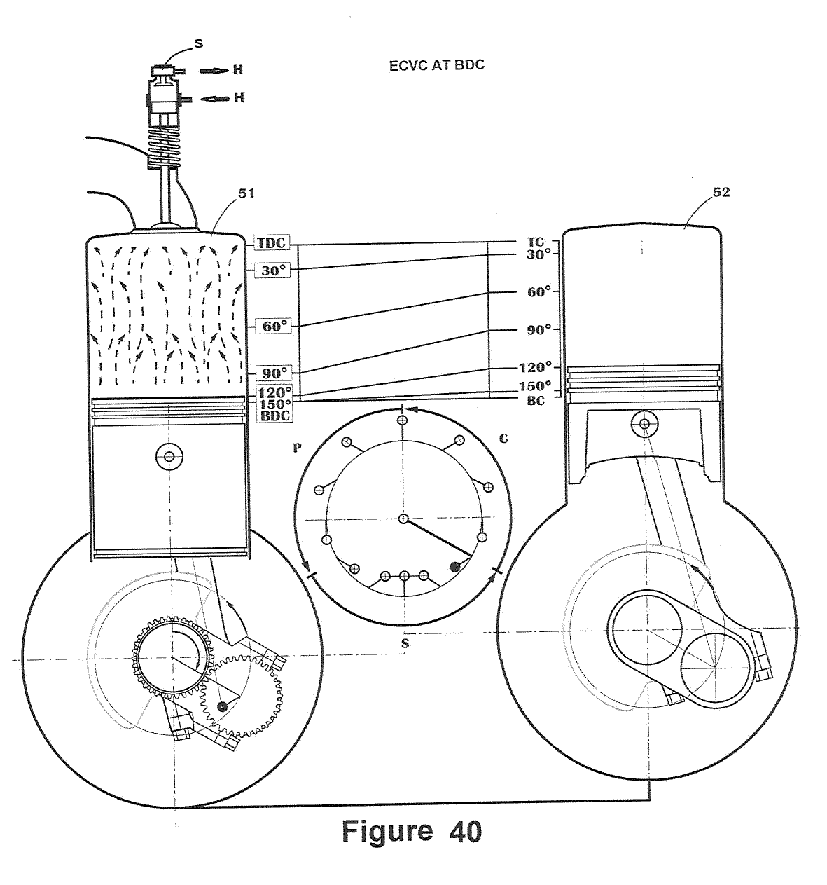

FIGS. 32-40 present the implementation of a reconfigured version of the crankshaft elements where ECVC appears at BDC point, this time only in a single piston two cycle concept with port inlet around BDC. The conventional two-four cycle concept theoretically has only 180° radial duration of each operational cycle. More often the time duration is altered or overlapped via “Budak”, “Atkinson” or Recompressing mode, thus the time duration of each cycle is relative to the RPM of the engine. FIGS. 34-36 of this embodiment shows a gradually extended crank arm and rod angle until 105° after TDC, then reduces the crank radius to the end of the power stroke. As a reflection on this reconfigured crank elements, the concept 51 throughout a crank rotation is increasing the volumetric displacement faster than conventional model 52.

This model has reduced expansion cycle to 120° of the angular duration after TDC labeled as ‘P”. A hydraulically controlled valve opens and depressurizes the cylinder at 120° and closes it at 130° while the intake ports are exposed simultaneously. The remaining crank rotation from 130°-240° is reserved for an extended scavenging time duration to boost the efficiency and is labeled with “S”. The compression stroke starts at 240° and ends at TDC labeled as “C”. The animation presents only an alternative way of opening the exhaust valve by hydraulic means as seen on today's large marine two cycle engines. This mechanical concept with extra-long but adjustable scavenging time duration brings several advantages: a) increases the volumetric-scavenging efficiency, b) decreases the mechanical energy needed to provide high pressure which has to enter the cylinder throughout extremely short time duration by a conventional concept, and c) As a result of the two characteristics above allows the engine to operate at higher RPM. The novel engine concept provides new dynamics of the crankshaft which can be used as well with the “crosshead element” which is characteristic for marine and some other stationary concepts. This may increase the RPM of the engine and appreciably increase the power.

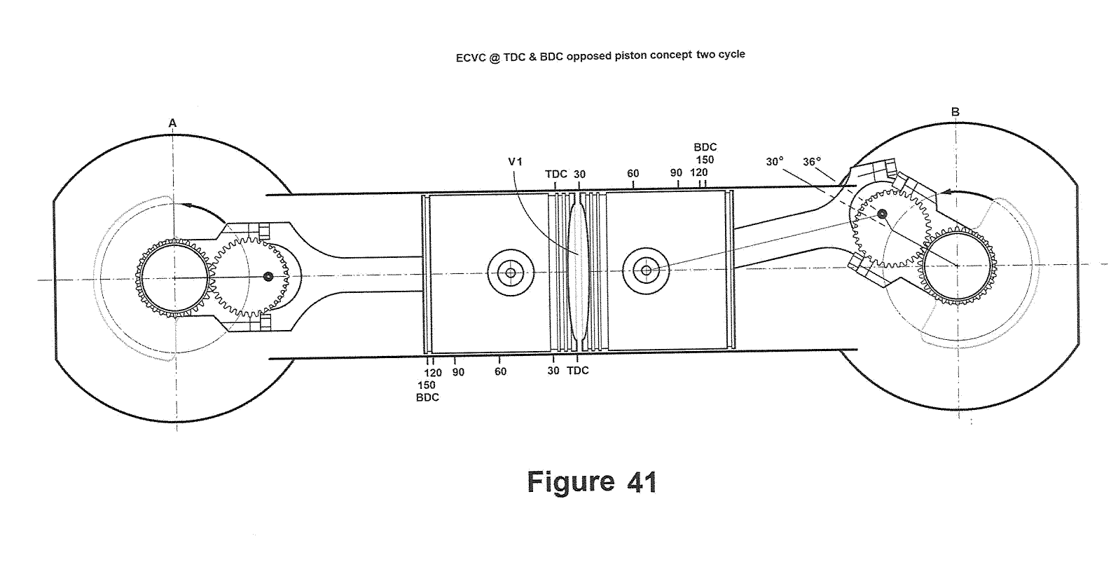

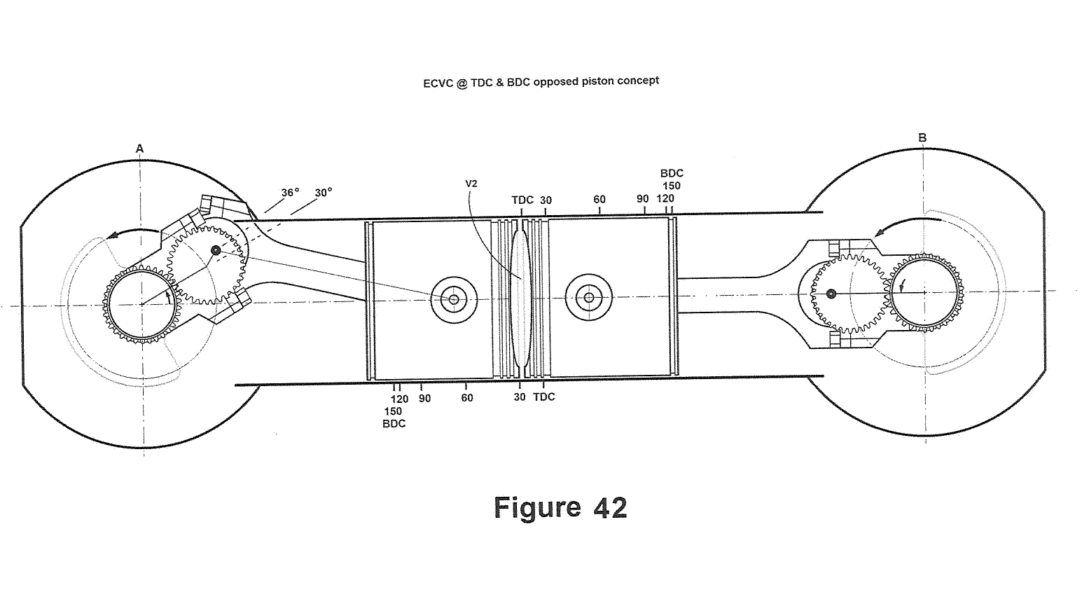

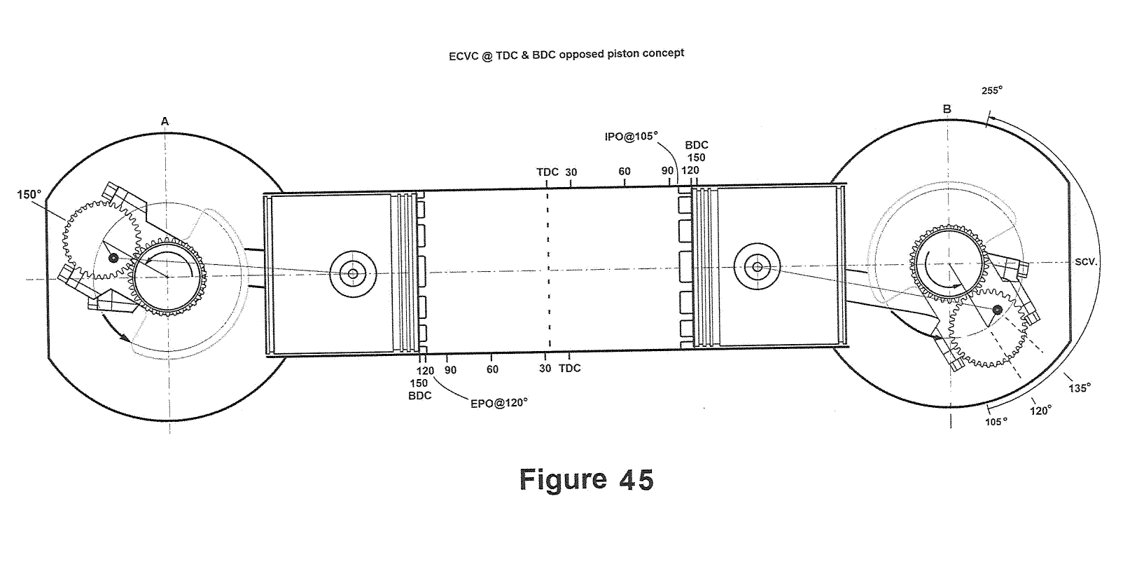

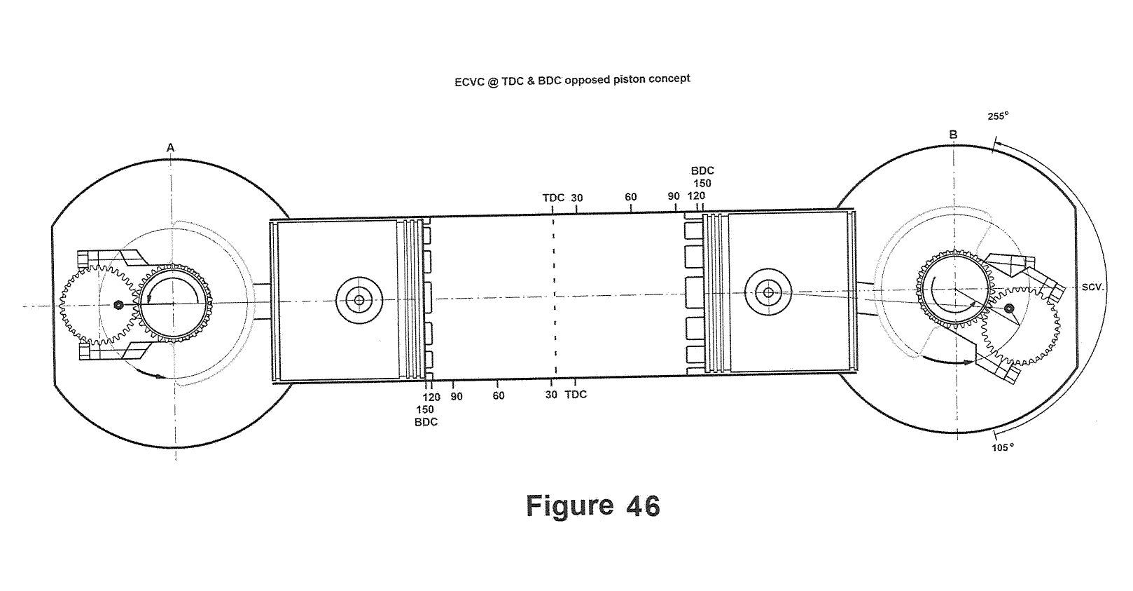

FIG. 41-47 shows an ultimate VR/SR OPOC concept, where ECVC is mechanically set to appear at DBC point and its implementation in opposed piston layout two cycle with exhaust port and intake port around BDC and having fuel injectors in the middle of the cylinder. The following figures are disclosing the way to create ECVC or EDDUR at TDC by rearranging the reciprocating and revolving opposed crank elements in the following way.

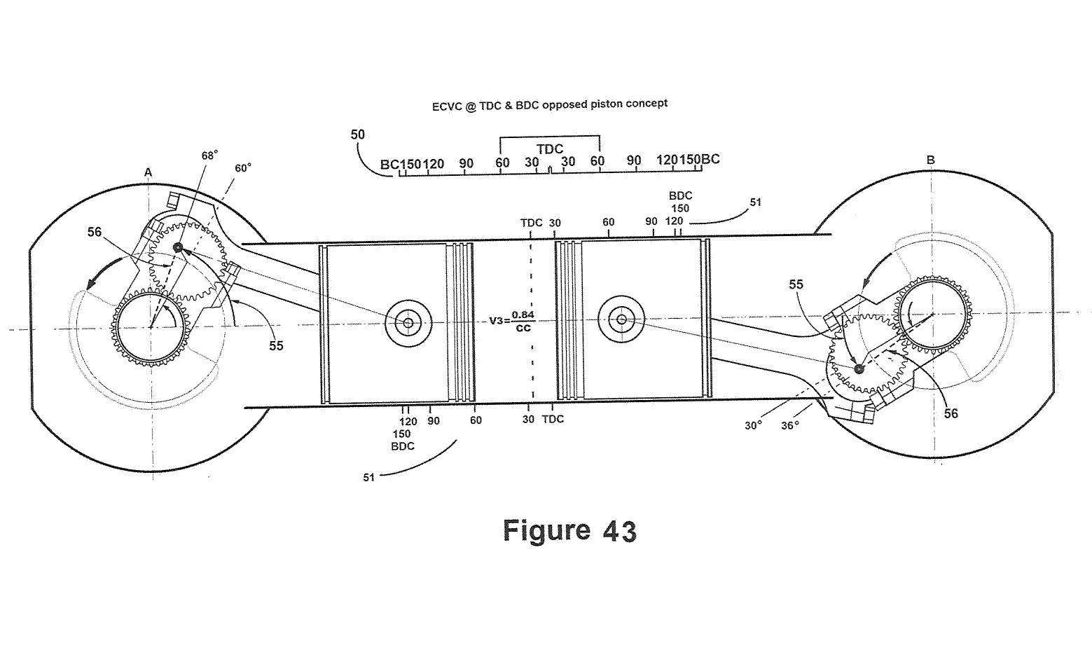

The engine A has 1.62:1 rod-stroke ratio and is opposed with the engine B with 1.71:1 vr/sr. When geometrically analyzed, the engine B has an extended connecting rod for a length equal to 0.75 of engine A's piston response from its own TDC to 30°. Engine B's crankshaft is angularly delayed for 30° from the selected combined engine's rotation in a counter direction. Retaining those specific as seen on FIG. 43 the concept will have 22:1 compression ratio. A multi-dimensional combustion chamber volume is provided in between the two piston's crows incorporating the minimum distance from piston A reach and piston B, illustrated on FIGS. 41 & 42. Throughout the mechanically combined crank rotation in the same direction, the two opposed pistons will follow one another for 30°, holding the volume substantially constant. In this way, the concept has achieved ECVC or EDDUR at TDC for better fuel propagation with slower volumetric increase in the cylinder until 90° after TDC, as compared to the conventional opposed engagement.

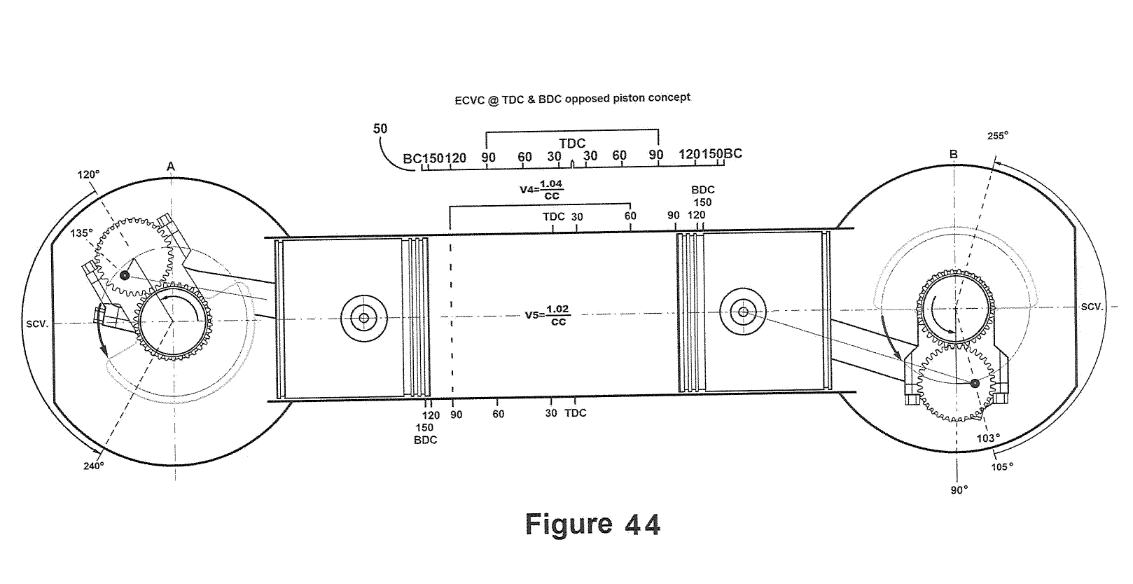

When the two opposed pistons simultaneously move in opposed directions, the volume in the cylinder is increased at twice the rate seen by a setup of the conventional OTTO model. The ultimate VR/SR OPOC concept model provides the increase of the volume at reduced rate, so from 30°-60° before and after TDC point the average value is at 0.68:1, than around 60° is 0.84:1 further and at around 90° is registered almost equal to conventional opposed concept and is 1.02:1 as shown in the FIG. 44 with comparable scalar 50. The concept creates the dual cycle by increasing the MEP and cylinder pressure through no increase of the volume temporarily without motion of the piston, and then increasing the volume at a slower rate and the slow increase of the volume promises a substantial improvement in torque, power rating and power/weight ratio. A fuller and more complete atomization process at earlier crank angle promises silent engine operation, with clean exhaust cycle and reducing the need for conventionally known techniques and methods to dissolve the unburned gas.

This model uses setting of the inverted orbital-epicyclic crankshaft to provide ECVC (EDDUR) at BDC, doubling the time for scavenging and feeding of fresh air from a supercharger or naturally aspirated system, thus creating an extended scavenging cycle which occupies 120° cr.angle and is labeled as “SCV” in the FIGS. 43-47. FIGS. 43 and 44 shows conventional concept piston-crank relationship scaler for comparison 50 and 51 for the VR/SR model. As the center of the orbital pin C1 orbits in an epicyclic motion around the stationary collar gear with center C2, it follows an irregular but symmetric path, starting from TDC point to 105°. The concept provides gradually increased crank lever factor 56 and positive arm with the rod angle, labeled 55 on FIG. 43. This concept resolves the issue of conventional opposed piston engines, where there is a large gap in the fuel propagation process due to an inadequate volume increase rate during the most important conversion angle, from TDC to about 120°.

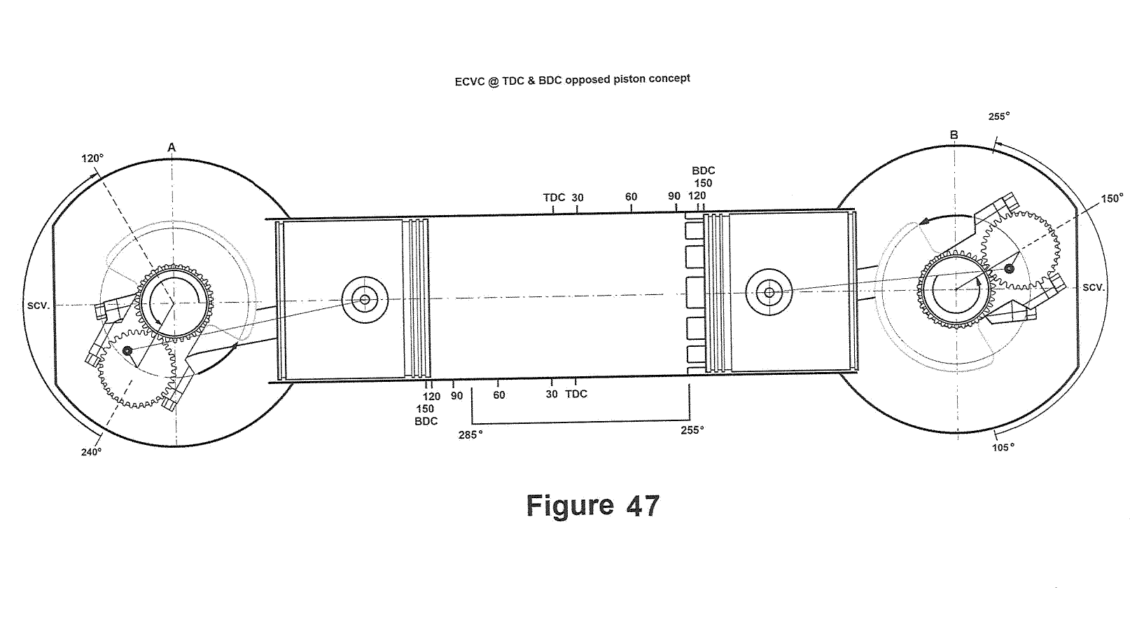

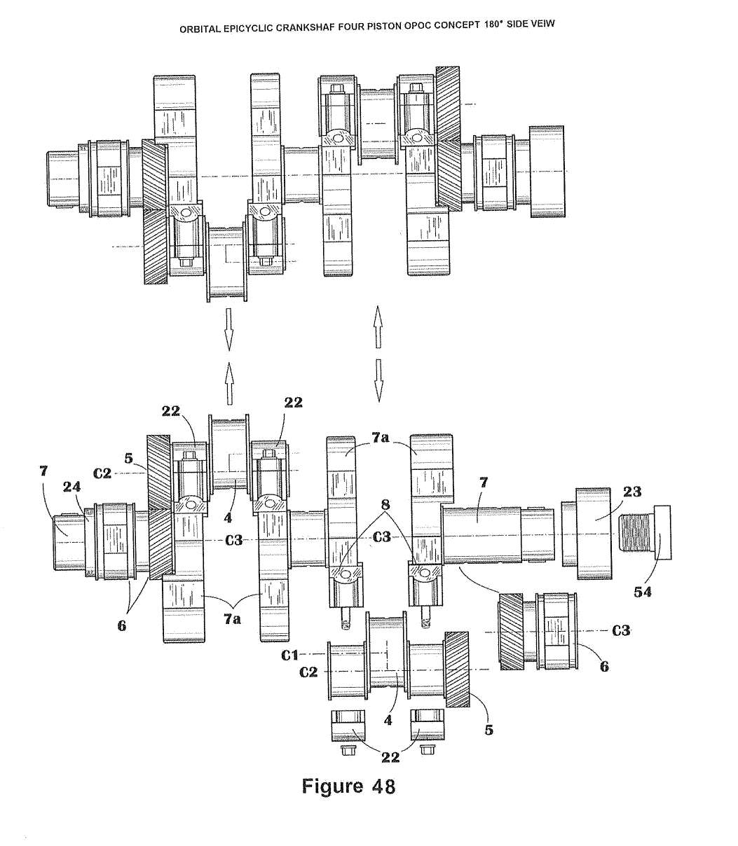

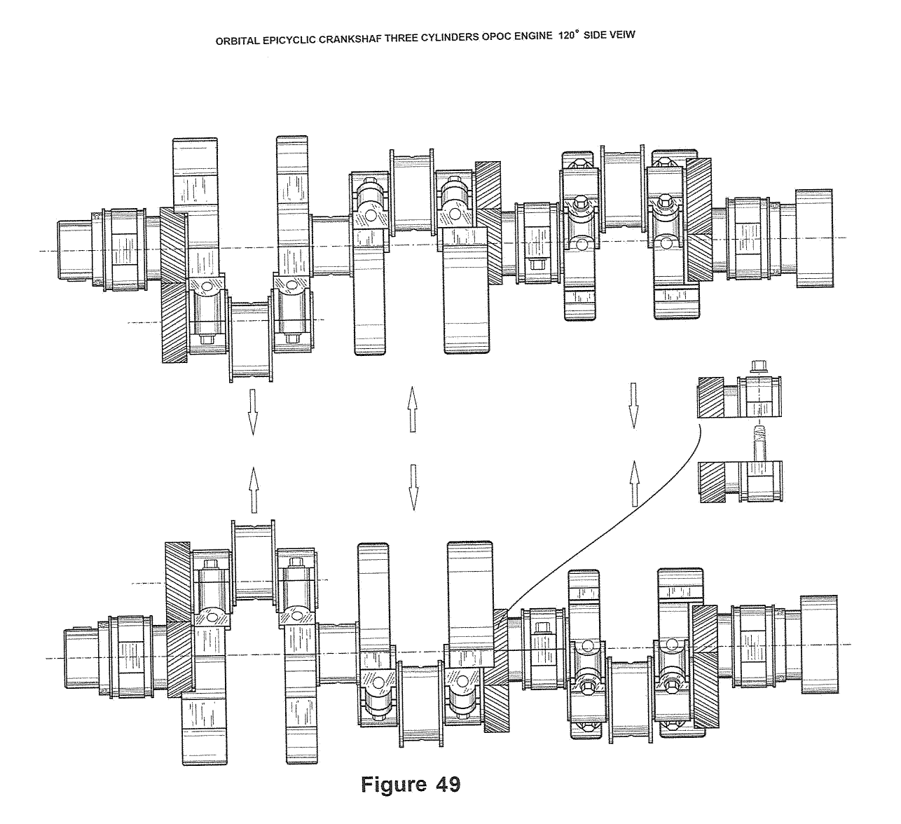

Further on the VR/SR OPOC engine, after the exhaust port closes by the engine A at 240° using the piston's reciprocating motion, the engine easily allows up to 45° of the EDDUR until the piston B reaches its own 255° to close the inlet ports. The method improves scavenging efficiency without interrupting the angular momentum of both crankshafts. As a result of a specific offset of the crankshafts and new kinematics of crank elements, the VR/SR OPOC engine uses 0.97% of its total swept volume, which is a much greater volume than the conventional OPOC concept. The details are illustrated in FIG. 47.

The VR/SR OPOC system addresses the problematic horizontal overall length of the prior art OPOC concept. The engine developers and the experts of today's OPOC engine are actually turning the prior art engine to a tilted angle to fit it in the space normally reserved for conventional straight or V configuration engines. While the illustrated embodiments show a mechanically and internally determined relationship between the orbital rod journal radius and rotation rate of the orbital journal geometry within a single rotation of the crank, it will be appreciated that the presented opposed concept has reduced the horizontal length of the engine due to offset position of the connecting rods towards the center of the rotation (main journal) when the pistons are at BDC and overlapping pistons position around TDC. The presented geometry of the VR/SR OPOC concept reduces the overall horizontal length of a three liter OPOC engine up to 2.5 inches.

It will be appreciated that a system and method for improved engine operation have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

We claim:

1. An internal combustion engine comprising:
a) a crankcase,
b) a rotating crankshaft held by the crankcase and stationary bearings,
c) an epicyclic gear set having a ratio 1:1,
d) a helical style planetary gear having an orbital shaft in the same center, orbiting inside two piece crank arms with oil film bearings, having at least one orbital pin eccentrically offset from the orbital shaft center to constitute one body,
e) a collar style stationary sun gear affixed to the crankcase, wherein a straight center bore allows the main shaft to rotate via sliding oil film bearings on one side, while on the other side a main shaft journal rotates inside a conventional sliding bearing mechanically fixed to the block with a bearing cap,
f) an orbital shaft with two orbital pins eccentrically offset from the orbital shaft center in accordance with disclosed principals, and radially opposed for 120° or 180°, together with planetary helical gear being linked in a epicyclic motion with stationary-collar sun gear, such that any of the angular changes of the orbital pin causes the main shaft to rotate in the same direction via crank arms,
g) at least two sets of epicyclic gears linking the orbital shafts together with opposed orbital pins to the main shaft and to the crankcase, having one crank throw radially opposed from another for 180° around main shaft center of rotation, such that epicyclic rotation of the orbital pins causes rotation of the main shaft in the same direction, and
h) at least three sets of epicyclic gears linking the orbital shafts together with two orbital pins to the main shaft and to the crankcase, having crank throws radially opposed every 120° around main shaft center of rotation, such that epicyclic rotation of the orbital pins causes rotation of the main shaft in the same direction,

2. The internal combustion engine in accordance with claim 1, wherein the center of the orbital pin offset distance from the revolving and orbital center of the orbital shaft center is subject to change to create a variety of ECVC time duration (EDDUR), and variety of piston-crank relationships.

3. The internal combustion engine in accordance with claim 1 or 2, wherein the orbital shaft together with orbital pin(s) and planetary gear(s) is set for the kinematics of the engine, wherein the ECVC at the new crank-piston relationship appears at the TDC point to improve four cycle engine operation.

4. The internal combustion engine in accordance with claim 1 or 2, wherein the orbital shaft together with orbital pin(s) and planetary gear(s) is rotated for 180° around its own center of rotation versus the stationary sun gear, to reconfiguring the kinematics of the engine, wherein the ECVC and new crank-piston relationship appear at the BDC point to improve scavenging efficiency during two cycle engine operation.

5. The internal combustion engine in accordance with claim 1, 2, 3 or 4 comprising three orbital pins on one orbital shaft, further radially separated by 120° around center of C2 (orbital shaft), axially separated and opposed by 180° around main shaft center to create 3+3 radial layout 6 cylinder engine.

6. The internal combustion engine in accordance with claim 1, 2, 3 or 4 using a cross head element between the piston rod and connecting rod.

7. The internal combustion engine in accordance with claim 1, 2, 3, 4, 5 or 6 wherein the engine is naturally aspirated or fed with force induction.

8. The internal combustion engine in accordance with any of claims 1-7 using two or four cycle engine operation.

9. The internal combustion engine in accordance with any of claims 1-8 using conventional or nonconventional valve systems.
